(19) United States
(12) Patent Application Publication
(10) Pub. No.: US 2011/0116475 A1
(43) Pub. Date: May 19, 2011

(54) VERTICAL HANDOFF METHOD, VERTICAL HANDOFF SYSTEM, HOME AGENT, AND MOBILE NODE

(75) Inventors: Mohana Dhamayanthi Jeyatharan, Singapore (SG); Keigo Aso, Kanagawa (JP); Chan Wah Ng, Singapore (SG); Chun Keong Benjamin Lim, Singapore (SG)

(73) Assignee: PANASONIC CORPORATION, Osaka (JP)

(21) Appl. No.: 13/001,137

(22) PCT Filed: Jul. 22, 2009
(86) PCT No.: PCT/JP2009/003428

§ 371 Date: Dec. 23, 2010

(30) Foreign Application Priority Data
Jul. 23, 2008 (JP) 2008-189951 2008

(51) Int. Cl. H04W 36/00

(52) U.S. Cl. 370/331

(57) ABSTRACT

The invention provides a technique to reduce a packet size of signaling to request vertical handoff in case a mobile node has static vertical handoff rules. According to this technique, MN 500, which has an If1, a WiMAX If2 and a WLAN If3, each being communicable with a PMIPv6 domain 511, roams within the PMIPv6 domain 511, and when the WiMAX If2 or the WLAN If3 is selectively and newly connected to WiMAX or WLAN, a prefix P2 to uniquely transfer the prefix P1 relating to If1 without transferring the prefix P1 relating to If1 to the WiMAX-If2 and the WLAN-If3, and to uniquely transfer from the WiMAX If2 previously connected or the WLAN If3 previously connected to the WiMAX If2 or the WLAN If3 newly connected to the LMA/HA 512 so that ID's of If2 and If3 are not contained in a trigger message of the vertical handoff as transmitted by MN 500.

### TECHNICAL FIELD

The present invention relates to a vertical handoff method and a vertical handoff system to shift a prefix relating to an interface of a mobile node to another interface when a mobile node having a plurality of interfaces is roaming.

The invention also relates to the mobile node as given above and its home agent.

### BACKGROUND ART

Currently, a great number of communication systems are performing communication by using Internet Protocol version 6 (IPv6). To offer mobility support to the mobile devices, Internet Engineering Task Force (IETF) is developing Mobility Support in IPv6 (MIPv6) as described in the Non-Patent Document 1. The mobility support disclosed in the Non-Patent Document 1 realizes an entity called a home agent (HA) in a home network of a mobile node (MN). MN registers a care-of address (CoA) acquired in an external link to HA and registers it by using a message called “binding update” (BU) message. By the BU message, HA can generate binding (location information) between home address (HoA), which is an address acquired in home link, and CoA of MN. HA intercepts a message destined to HoA of MN, and after encapsulating it in a packet destined to CoA of MN, it is transferred. The packet encapsulation is a processing to set a received packet in a payload of a new packet, and it is known as packet tunneling. The MIPv6 is a protocol, by which MN, i.e. a client, carries out mobility management, and it is also called Client Mobile IPv6 (CMIPv6) or Host Based Mobility (HBM).

One of the problems in the MIPv6 is that it is necessary to update the registration. MN must update the registration to one or more HAs and correspondent nodes (CN's) each time when network attachment is changed or when effective period of the binding is terminated. By this updating, MN, which is moving at high speed, increases the load of signaling to be discharged to wireless network. Further, at the time when the handoff is performed to and from CN (it is assumed here that route optimization is used), it is necessary to transmit and receive an Return Routability (RR) message and a BU message each time the network attachment is changed, and this means that much time is required. For this reason, considerable time is needed during the session relating to flow or connection, and jitter or packet loss occurs. The jitter as such is not desirable for real time application such as multi-media or video streaming for Voice over IP (VoIP). Further, the packet loss is not desirable for the flow, which transfers important text or data information. Also, when TCP (Transmission Control Protocol) is used to transfer important data and application, the packet loss leads to the reduction of the throughput of TCP.

When attention is focused on the problem of the MIPv6, the focus is currently shifted to Network-based Mobility Management (NetLMM) protocol. The NetLMM working group of the IETF is now working on this protocol. In the Network-based Local Mobility Management, discussion is made on the management of the mobility of MN at geographically local network segment, which is to be managed by network entity rather than MN itself.

In order to attain the purpose of the Network-based Local Mobility Management, which is transparent to MN, MN must refer to the same prefix regardless of where it is located in a local domain. The prefix as described above must be acquired from a router, which is located on an upper layer of routing hierarchy. Preferably, this router should be located on default routing path of all MN's in a local domain so that advantages of the local mobility management can be available. The router as described above is a route of the prefix as given above and must have information of reachability relating to the prefix as given above, i.e. it must have routing information (prefix-based route). As a result, the prefix-based route must be generated by the network entity.

A specific type of the network-based local mobility management protocol as studied by the NetLMM Working Group is the PMIPv6 (Proxy Mobile Internet Protocol version 6) as disclosed in the Non-Patent Document 2. The protocol of the PMIPv6 is primarily designed to provide mobility management service on a local part of the network to a normal IPv6 host, which does not have the CMIPv6 (Client Mobile IPv6) stack, and it is also called NBM (Network-based Mobility). In spite of this, the PMIPv6 is also useful for the node, which has the CMIPv6 stack. The reason is as follows: When an MN having the CMIPv6 stack is located in an external PMIPv6 domain and when it refers to the same prefix via an interface in the local domain (i.e. an external local mobility anchor (LMA/HA) prefix to be routine at an external local mobility anchor (LMA/HA)) via an interface within the local domain, MN has no need to execute global registration whatsoever. Further, when MN, which has the CMIPv6 stack as described above, roams in the home domain, it need not participate in location registration by continuously referring to its own home network prefix even when it has changed geographical position. An LMA is a node, which manages location information of MN to use the PMIPv6, and its location is registered from the mobile access gateway (MAG) as to be described later. The LMA/HA means a network node, which has both of the function of LMA in the PMIPv6 and the function of HA in the MIPv6.

Description will be given below on general features of the PMIPv6 as disclosed on the Non-Patent Document 2. When a certain MN is attached to a certain PMIPv6 network, this MN offers its own network access identifier (NAI) during its association with the mobile access gateway (MAG). MAG is a router (proxy node), and this executes local registration as a proxy of MN to a local mobility anchor (LMA), to which MN is directly attached or MN is under its control. For the purpose of authentication, NAI is transferred to an AAA (Authentication, Authorization and Accounting) server. When the AAA server authorizes network attachment of MN, a response is sent back to notify MAG that the authentication has been successfully performed. In the response as given above, the AAA server provides an address arrangement mode, which MN must have during the roaming in the local domain, or offers several MN profiles such as a special policy.

When the parameters of MN as given above have been acquired, a proxy BU (PBU) message is transmitted to LMA. From the proxy binding acknowledgment (PBA) message, which is a response of the PBU message, MAG acquires a prefix relating to the interface, to which MN is attached. Then, home link and local home link are emulated. The PBU message executed by MAG as described above, i.e. local registration, is the same as the BU message of the MIPv6 except only the flag, which indicates that this message is a PBU message. By executing the PBU message, the state of reachability of MN is generated at LMA. Basically, LMA has the state of reachability to MN prefix as acquired in the PMIPv6 domain, and the address reachable to this MN prefix is an address of MAG.

Using address arrangement mode with the state or without the state, MN sets up an address by using a prefix received in the PMIPv6 domain. Each MN has its unique prefix, and the prefix-based cache at LMA reaches MN sufficiently. After reaching LMA, each data packet is tunnelized to MAG, which is connected to MN, and each data packet reached MAG is tunnelized to LMA. A neighbor cache table of MAG performs binding of PMIPv6 local address of MN to a link layer address to be used for the transmission of the packet.

The protocol of the PMIPv6 as disclosed in the Non-Patent Document 2 provides transparent proxy mobility service to MN and also provides multi-homing service. In the multi-homing service as described in the Non-Patent Document 2, MN, which has a plurality of interfaces, can be attached to the PMIPv6 domain via all interfaces, and it can also roam in the PMIPv6 domain without changing the layer 3 protocol and also without participating in the signaling relating to mobility. Basically, according to the method described in the current draft of the Non-Patent-Document 2, for the purpose of supporting the multi-homing, LMA gives a unique prefix to each of the interfaces of MN. Also, LMA maintains PMIPv6 binding relating to the interfaces of MN as individual mobility session. The protocol of multi-homing of the PMIPv6 should guarantee as follows: to guarantee unique prefix in the first attachment of each interface when MN having a plurality of interfaces performs roaming, and to maintain the session to be established by using the prefixes as described above for providing completely transparent proxy mobility management service.

In this case, there are two handoff events, depending on the mobility, the layout structure of cells, the wishes of MN, and the power-saving mode operation of MN. The first is horizontal handoff, in which an interface of a specific access technology type of MN is disconnected from a certain MAG, and the interface is shifted and re-connected to a new MAG. In order to maintain the continuity of the session of the flow relating to the prefix under the horizontal handoff, it is important that MN refers to the same prefix when it is attached to the new MAG after the horizontal handoff. In the event of the horizontal handoff, to assign the same prefix, LMA may use the interface identifier or the access technology type (ATT) in the PBU message from the next MAG (i.e. a new MAG) and may use a handoff identifier in the PBU message HI (=3). This interface identifier is an identifier of the interface in the horizontal handoff or an identifier of the interface connected to the new MAG. Also, ATT means types of interfaces connected (i.e. cellular, WiMAX, WLAN, etc.). On the other hand, the handoff identifier HI can indicate whether it is a handover connection to maintain the address or it is a new connection without maintaining the address, depending on the designated value. An important point in this case is to understand that the processing of the horizontal handoff is not too complicated. The reasons are as follows: When LMA acquires interface identifier or ATT in a new PBU message in the horizontal handoff and an entry containing the same value as that of the interface identifier or ATT is retrieved in the cache, the same prefix can be given, and this leads to the continuity of the session. In case the value of the handoff identifier HI indicates the handover, LMA refers to information of prefix as assigned to MN from among the types of information, i.e. information relating to MN held by LMA or information acquired from the authentication server or MN information management server, and it can be judged that this prefix should be assigned to MN again.

However, ideally speaking, LMA does not need the HI option as described above for the horizontal handoff. The reason for this is that LMA can carry out the horizontal handoff by simply performing the matching of the interface identifier, which is present in the cache with the identifier of the interface attached to the new MAG. In the Non-Patent Document 2, a plurality of methods to support the horizontal handoff are described. However, there is one method to support the horizontal handoff, and there is no need to restrict to the other methods.

Next, brief description will be given on several methods described in the Non-Patent Document 2 for the purpose of supporting the horizontal handoff. In case the prefix, which must be referred during the horizontal handoff, is attached in the new PBU message, LMA checks whether or not the binding to this prefix, the interface identifier connected to the new MAG, and NAI are present in the cache. If these are present, LMA assigns the same prefix by the PBA message.

In most cases, however, when the horizontal handoff is executed, it is not necessary to attach the prefix to be referred after the horizontal handoff in the PBU message, which is to accomplish the horizontal handoff. To attain the continuity of the session in the horizontal handoff, it would be sufficient if MN has an option of the interface identifier (If-ID) even when it has no prefix, and ATT (Access Technology Type) and NAI can be simply notified. In this case, the horizontal handoff can be executed by checking whether there is an entry or not, which has a parameter consistent with those of the parameters in the new PBU message (i.e. If-ID, ATT and NAI attached to the new MAG as given above). In case LMA has discovered an entry with the same parameters in the cache, this cache is updated by a new entry in the new PBU message. The only point to be changed in the cache of LMA is that care-of address (CoA) of the PBU message is changed to CoA relating to the new MAG. Detailed operation of the horizontal handoff is described in the Non-Patent Document 2.

As another type of handoff to be carried out by MN, there is vertical handoff. In the basic draft as disclosed in the Non-Patent Document 2, one specific type of the vertical handoff is described. In this type of the vertical handoff, the interface of a specific access technology type of MN is disconnected from MAG, and a flow relating to the disconnected interface is shifted to the interface of another access technology type attached to the PMIPv6 when power is turned on. The vertical handoff of this type can be generated by a number of reasons. These reasons are: the range to be covered by the domain of a specific access technology type is insufficient, or it is wanted by MN, or MN wants to shut down the interface to save electric power.

The complicated point of the vertical handoff when compared with the horizontal handoff is that the LMA does not have sufficient parameters in the attachment procedure to be performed from other interface of MN in order to give correct prefix for the vertical handoff LMA. The parameters for the new attachment are: If-ID, ATT and NAI of the interface when the power to MN is newly turned on. In case a plurality of MN have PMIPv6 binding attached to LMA, the PBU message to realize the vertical handoff must be attached with a prefix, which is needed for the handoff to the new interface, or If-ID of the interface to be shut down must be attached. The reason for this is that LMA must identify which of the prefixes is shifted to the new interface. Therefore, information to instruct the interface to be shut down must be transmitted during the vertical handoff operation. This information is particularly important when two or more PMIPv6 bindings are present in LMA.

Here, if the parameters of the interface attached of MN (i.e. If-ID, ATT and NAI attached to the new MAG as described above) are sufficient—that is, in case of the horizontal handoff, it can be accomplished by normal PMIPv6 operation. Therefore, to attain the horizontal handoff, no special types of information (such as ID of the interface to be shut down or prefix/flow to be shifted by the vertical handoff) are not needed, and there is no problem.

The 3GPP (Third Generation Partnership Project) is now working on global different type network structure having various types of wireless access networks such as wireless local area network (WLAN), cellular network (i.e. cellular networks of third generation (3G), 3.9th generation, 4th generation and cellular networks of subsequent generations), and wireless wide area network (WAN) of WiMAX type. In the following, several special terms are used, to which 3G or 3GPP is added. In the present specification, these terms means “cellular”, and these terms are used not only to 3G, but also to 3.9G, 4G or subsequent generations. The global different type network structure realizes seamless mobility and it is useful for the supporting high quality of service in the cases such as real time video, VoIP (Voice over IP), information important data and different types of application services. The Non-Patent Document 3 discloses that the PMIPv6 would be adopted as a local mobility management (LMM) protocol in the 3GPP local domain. The 3GPP local domain may comprise 3G cellular network, WLAN access network reliable or non-reliable, and WiMAX access network. Further, it is quite probable that MN, having a plurality of different types of interfaces, may roam in the 3GPP local domain and may accomplish multi-homing through simultaneous attachment via various types of interfaces. Other types of the prior art are disclosed in the Patent Documents 1, 2 and 3 as given below.

### PRIOR ART DOCUMENT

### Patent Document

[Patent Document 1] Yoshihiro Oba: “Mobility architecture using pre-authentication, pre-configuration and/or virtual soft-handoff”; U.S. Pat. No. 7,046,647 B2; May 16, 2006.
[Patent Document 2] Raziq Yaqub: “Dynamic use of multiple IP network interfaces in mobile devices for packet loss prevention and bandwidth enhancement”; U.S. Patent Application Publication No. 2007-0140256 A1; Jun. 21, 2007.
[Patent Document 3] George Tsirtsis, et al.; “Wireless terminal methods and apparatus for establishing connections”; U.S. Patent No. 2007-0081521 A1; Apr. 12, 2007.

### Non-Patent Document

[Non-Patent Document 1] Johnson, D. B., Perkins, C. E., and Arkko, J.: “Mobility Support in IPv6”; Internet Engineering Task Force Request for Comments 3775; June 2004.
[Non-Patent Document 2] Gundavelli, S., et al.: “Proxy Mobile IPv6”; Internet Engineering Task Force (IETF) Working Group Draft: draft-sgundave-mip6-proxymip6-02.txt; Mar. 5, 2007.
[Non-Patent Document 3] “3GPP System Architecture Evolution; Report on Technical Options and Conclusion”; 3GPP TR 23.882, VI. 12.0, October 2007.

Referring to FIG. 12A, FIG. 12A, FIG. 12C and FIG. 12D, detailed description will be given below on various types of cases of the vertical handoff. FIG. 12A, FIG. 12B, FIG. 12C and FIG. 12D show four cases of vertical handoff operation respectively. Two cases shown in FIG. 12A and FIG. 12B are the cases where MN 10A and MN 10B have two interfaces If1 and If2 respectively and execute the vertical handoff. The two cases shown in FIG. 12C and FIG. 12D are the cases where MN 10C and MN 10D have three interfaces If1, If2 and If3 respectively and execute the vertical handoff.

(a) First, description will be given on the vertical handoff of the case shown in FIG. 12A. In case of MN 10A, it is supposed that only the interface If1 is active in the initial state, and it is connected to the PMIPv6 domain by routing to the LMA/HA 13A via a link 17A and MAG 11A. Next, it is supposed that MN 10A shuts down the interface If1. Then, power to the interface If2 is turned on and the vertical handoff is carried out. Also, it is supposed that, by L2 attachment or by router solicitation or by other means, an instruction of the vertical handoff is notified to MAG 12A, and the interface If2 is newly attached via a link 15A. Therefore, MN 10A notifies the vertical handoff state to MAG 12A.

An important point to be understood in this case is that the vertical handoff is triggered when MN 10A is attached to MAG 12A (vertical handoff trigger message 14A). Otherwise, a new prefix may be assigned when the interface If2 is attached to the LMA/HA 13A via MAG 12A. This is because the LMA/HA 13A does not accurately recognize the wish of MN 10A (i.e. whether it is vertical handoff via the interface If2 or a new attachment). The only parameter to be transmitted by a trigger message 14A of the vertical handoff is a handoff identifier (MN trigger->HI=2 in the figure). After the trigger message 14A, the LMA/HA 12A receives information of the vertical handoff by a PBU message (not shown) to be transmitted from MAG 12A (i.e. HI option=2, and option of the interface identifier relating to the interface If2).

When the PBU message is received, the LMA/HA 13A assigns a prefix P1, which has been given to MAG 11A for the interface If1. When the prefix P1 is received by the PBA message (not shown) from the LMA/HA 13A, MAG 12A transmits the prefix P1 to the interface If2 by RA message or signaling 16A such as an ACK signal (Response->(P1) in the figure).

An important point to be understood here is that, when MN 10A having the two interfaces If1 and If2 carries out the vertical handoff, a trigger option of handoff, i.e. HI option, would be sufficient as the information needed to assign the correct prefix P1 during the vertical handoff. The reason for this is as follows: There is only one entry of the LMA/HA 13A when the option of the request of the vertical handoff from MAG 12A reaches the LMA/HA 13A, and when the vertical handoff is requested via the interface If2, the LMA/HA 13A is confident that it is necessary to shift the prefix P1 relating to the only one entry.

(b) FIG. 12B shows a case where MN 10B shuts down the interface If1 and shifts the flow to the interface If2, which is currently present. The interface If2 is already attached to this system, and the prefix P2 is assigned. On the other hand, the prefix P1 is assigned to the interface If1. It is supposed here that, similarly to the case of FIG. 12A, MN 10B is disconnected from the MAG 11B and the link 17B (i.e. shuts down the interface If1) and carries out the vertical handoff via the interface If2, which is already attached to the link 15B and the MAG 12B. When a trigger message 14B (MN trigger->HI=2 in the figure) of the vertical handoff from the interface If2 is received, MAG 12B inserts HI option in a new message or in a PBU message (not shown) to be transmitted to the LMA/HA 13B. This message may also include the identifier of the interface If2.

When this message is received, the LMA/HA 13B checks whether or not there is only one binding relating to the interface If1 in addition to the PMIPv6 binding of the interface If2. If there is only one binding, the prefix P1 is shifted to the interface If2. Basically, the PMIPv6 binding of the interface If2 contains those for two prefixes P1 and P2. As a response to the trigger of the vertical handoff, the LMA/HA 13B notifies the prefixes P1 and P2 when the ACK signal (not shown) is transmitted to the MAG 12B. Therefore, the MAG 12B transmits a response message 16B (Response->(P1, P2) in the figure) containing both of the prefixes P1 and P2 to the interface If2. This is the new assumption example of the vertical handoff. The case where such operation occurs is a case where MN 10B shuts down a certain interface for power-saving and shifts the flow to the interface currently present. When the vertical handoff is carried out from the interface If1 and the prefix P1 is sent back to the interface If1 in case the interface If1 is connected to MAG 11B and the link 17B again, the prefix P1 is present to specify a moving prefix in the trigger message (not shown) of the vertical handoff transmitted from the interface If1, and MAG 11B transmits a PBU message (not shown) including the HI option and the prefix P1 to the LMA/HA 13B. When this message is received, the LMA/HA 13B selects the prefix P1 as specified by the PBU message from among P1 and P2 as registered as the PMIPv6 binding of the interface If2, and transmits an ACK signal including the prefix P1 as a response to the trigger of the vertical handoff. Then, the MAG 11B transmits a response message (not shown) including the prefix P1 to the interface If1.

(c) Next, referring to FIG. 12C, description will be given on a case where MN 10C having three interfaces If1, If2 and If3 performs the vertical handoff. First, the interfaces If1 and If2 are attached to the PMIPv6 domain under routing to the LMA/HA 14C via links 15C and 16C and MAG 11C and MAG 12C, and MN 10C refers to the prefixes P1 and P2. On the other hand, the interface If3 is not attached yet. This state is referred as “initial connecting state” hereinafter. Next, MN 10C shuts down the interface If2, turns the interface If3 to be active, and decides the vertical handoff on the flow of the interface If2 to the interface If3.

When MN 10C carries out the vertical handoff and triggers MAG 13C, the trigger message 18C must contain more types of information than the case as shown in FIG. 12A and FIG. 12B. As these types of information, there are, for instance: a vertical handoff flag (may be optional), and a prefix P2 to be referred via the identifier of the interface If2, which has been shut down, or via the interface If3. The vertical handoff trigger information to be transmitted by the trigger message 18C, i.e. HI information, can specify “the vertical handoff” simply by one bit. However, when MAG 13C transmits a PBU message (not shown) to the LMA/HA 14C, this vertical handoff information must be included in an adequate option (HI option) as described in the Non-Patent Document 2.

Here, attention must be paid on the fact that the method to give the trigger of the vertical handoff to a new MAG, i.e. MAG 13C, is not described in the Non-Patent Document 2. Specifically, to the vertical handoff, striding over the domains of different types of access technology types (ATT), the network side cannot detect this step unless it is notified from MN side. Also, in the arrangement of 3GPP, no consideration is given on a case where the network side starts the handoff to the handoff operation, striding over the domains of different types of ATT. The reasons are as follows: For the network side, it is difficult to take such action via a long routing path from the domain of the other ATT. Further, vertical handoff must be executed according to dynamic wish and decision such as power-saving relating to a certain prefix of MN (it is desirable that this prefix is to be referred via the domain of ATT).

In FIG. 12C, when MN 10C gives these parameters of the handoff (MN trigger->HI=2, If2-ID/P2 in the figure) to MAG 13C, MAG 13C sets these parameters as the options in the PBU message (not shown). These options are that If2-ID of the interface If2 is present, If3-ID of the interface If3 is present, and that ATT option and HI option (HI=2) are present. When this PBU message is received, the LMA/HA 14C first identifies that this message is that of the vertical handoff (HI=2). Then, the LMA/HA 14C refers to If2-ID of the interface If2 in the PBU message and identifies that the entry of If2-ID is present in the cache. Then, the prefix P2 is shifted to the interface If3. Basically, the entry in the cache of the interface If3 is generated according to the prefix P2. The prefix P2 is notified by a PBA message (not shown) to be transmitted from the LMA/HA 14C to MAG 13C. When the prefix P2 is received, MAG 13C transmits the prefix P2 in an RA message of the signaling 19C of the ACK signal to MN 10C (Response->(P2) in the figure).

(d) Finally, description will be given on the vertical handoff shown in FIG. 12D. MN 10D has three interfaces If1, If2 and If3, and the interfaces If1, If2 and If3 are connected to the PMIPv6 domain under routing to the LMA/HA 14D via link 15D and MAG 11D, link 16D and MAG 12D, and link 17D and MAG 13D, and the prefixes P1, P2 and P3 are referred. MN 10D executes the vertical handoff of the interface If2, and the trigger message 18D of the vertical handoff (MN trigger->HI=2, If2=ID/P2 in the figure) is transmitted to MAG 13D. When the trigger message 18D is received, MAG 13D transmits a PBU message (not shown) to the LMA/HA 14D. As described above, the PBU message contains many parameters such as ID of the interface If2 or ID of the interface If3. When a PBU message from MAG 13D connected to the interface If3 is received, it can be identified that MN 10D is carrying out the vertical handoff of the interface If2 and wants to shift the flow of the interface If2 to the interface If3. In this case, the LMA/HA 14D gives correct prefixes P2 and P3 to MAG 13D. Then, MN 10D receives the prefixes P2 and P3 by a response message 19D from MAG 13D (Response->(P2, P3) in the figure).

An important point here is to distinguish the vertical handoff operation in a case where there are two interfaces from a case where there are more than two interfaces. In case there are two interfaces, the vertical handoff is simple to perform, and signaling load is very similar to the case of the horizontal handoff. The only difference is that the trigger message 18D of the vertical handoff is important. In the vertical handoff operation where there are more than two interfaces, a certain state information of the interface If2 to be shut down is needed when the vertical handoff operation is started.

As described above, when a mobile node having three interfaces fixes the prefixes relating to two interfaces among the three interfaces and performs static vertical handoff, a major problem lies in that the identifier of the interface, which is shut down, and the trigger message having a shifting prefix must be repeatedly transmitted each time the vertical handoff is performed. Also, when a mobile node having two interfaces summarizes the prefixes assigned to each of the interfaces to one of the interfaces, a major problem is that the trigger message having the prefix must be repeatedly transmitted each time the vertical handoff is performed. The interface identifier and the prefixes as such increase the packet size of the trigger message by its bit length. Further, it increases power consumption of the mobile node and signaling costs when the trigger message is transmitted. Further, the more the packet size of the trigger message is increased, the more the wireless bands must be used.

### SUMMARY OF THE INVENTION

To solve the problems as described above, it is an object of the present invention to provide a vertical handoff method, a vertical handoff system, a mobile node and its home agent, by which it is possible to reduce packet size of signaling to request vertical handoff when the mobile node has static vertical handoff rules and has three or more interfaces.

Also, it is another object of the invention to provide a vertical handoff method, a vertical handoff system, a mobile node and its home agent, by which it is possible to reduce packet size of signaling to request vertical handoff when the mobile node has two or more interfaces.

To attain the above objects, the invention provides a vertical handoff method where a mobile node having a first to a third interfaces connectable to a first to a third networks respectively, being provided with a proxy mobile IP under management by a common management node, said mobile node roams in said first to said third networks and said second or said third interface is selectively and newly connected to said second or said third network, wherein said method comprises:

a prefix setting step for setting said prefix on a home agent of said mobile node in order that said second or said third interfaces can be continuously used after said vertical handoff, and a prefix different from that of said first interface, being used before the vertical handoff to said second to said third network, can be used by said second or said third interface;

a step where said mobile node transmits a trigger message of the vertical handoff, including a vertical handoff flag and not including identifiers of said second or said third interface newly connected, to said home agent from said second and said third interfaces newly connected; and

a step where said home agent detects said vertical handoff flag in said trigger message, and the prefix set in said prefix setting step is shifted to said second or said third interface newly connected from said second or said third interface previously connected.

Also, to attain the above objects, the invention provides a vertical handoff system, where a mobile node having a first interface to a third interface, being connectable respectively to a first network to a third network, to which a proxy mobile IP managed by a common management node is provided, said mobile node roams within said first network to said third network, and said second interface or said third interface is selectively and newly connected to said second network or said third network, wherein said system comprises:

prefix setting means for setting a prefix to a home agent of said mobile node in order that a prefix different from said first interface and being in use before vertical handoff to said second network or said third network by said second interface or said third interface is continuously used via said second interface or said third interface after said vertical handoff;

means for transmitting where said mobile node transmits a trigger message of vertical handoff, including a vertical handoff flag and not including an identifier of said second interface or said third interface newly connected, from said second or said third interface newly connected to said home agent; and

means, by which said home agent detects said vertical handoff flag in said trigger message and transfers the prefix set by said prefix setting means from said second interface or said third interface previously connected to said second interface or said third interface newly connected.

Further, to attain the above objects, the invention provides a mobile node, having a first interface to a third interface connectable respectively to a first network to a third network where a proxy mobile IP managed by a common management node is provided, said mobile node is roaming in said first network to said third network and said second interface or said third interface performs vertical handoff to said second network or said third network newly connected selectively, wherein said mobile node comprises:

means for transmitting a trigger message of vertical handoff, including a vertical handoff flag and not including an identifier of said second interface or said third interface newly connected, said trigger message being transmitted to a home agent of a mobile node from said newly connected second interface or said third interface.

Also, to attain the above objects, the invention provides a home agent of a mobile node in a vertical handoff system, where a mobile node having a first interface to a third interface connectable to a first network to a third network respectively, where a proxy mobile IP managed by a common management node is provided, said mobile node roams in said first network to said third network, and said second interface or said third interface is selectively and newly connected to said second network or said third network, wherein said home agent comprises:

prefix memorizing means for memorizing a prefix different from said first interface and being used before the vertical handoff by a second interface or a third interface of said mobile node to said second network or said third network;

means for receiving a trigger message, being transmitted from said second or said third interface newly connected of said mobile node and including a vertical handoff flag and not including an identifier of said newly connected second or said third interface; and

means for detecting said vertical handoff flag in said trigger message and for transferring a prefix memorized in said prefix memorizing means to said second or said third interface newly connected from the second or the third interface previously connected.

With the arrangement as described above, the trigger message of the vertical handoff does not include an identifier of the newly connected interface. As a result, the mobile node has static vertical handoff rules, and if the mobile node has three or more interfaces, it is possible to reduce the packet size of signaling to request the vertical handoff.

Also, the invention is characterized in that the mobile node decides the prefix to be used continuously and to send it to the home agent.

Further, to attain the above objects, the invention provides the vertical handoff method where a mobile node having a first interface to a third interface connectable to a first network to a third network respectively, and a proxy mobile IP managed by a common management node is provided, said mobile node roams within said first network to said third network, and said second interface or said third interface is newly connected to said second network or said third network, wherein said method comprises:

a step of setting a prefix, said prefix to be set to a proxy node of said mobile node in order that the prefix, being used by second interface or by said third interface before vertical handoff to said second network, said prefix to be continuously used on said second interface or said third interface after said vertical handoff;

a step of transferring said prefix to be continuously used to and from said proxy node;

a step where said mobile node transmits a trigger message of the vertical handoff, including a vertical handoff flag and not including identifier of said second interface or said third interface newly connected from said second interface or said third interface newly connected to said proxy node;

a step where said proxy node receives said trigger message and notifies said prefix to be continuously used to said home agent; and

a step where said home agent shifts said notified prefix from said second interface or said third interface previously connected to said second interface or said third interface to be newly connected.

Also, to attain the above objects, the invention provides the vertical handoff method, where a mobile node having a first interface and a second interface connectable to a first network and a second network respectively where a proxy mobile IP managed by a common management node is provided, said mobile node roams within said first network and said second network, and said second interface is disconnected from said second network and is re-connected to said second network wherein said method comprises:

a step of setting a prefix, said prefix to be set to a home agent of said mobile node in order that the prefix, being used before the vertical handoff by said second interface to said second network, can be continuously used on said second interface even after said vertical handoff;

means for transmitting a trigger message of the vertical handoff, including a vertical handoff flag and not including said prefix to be continuously used, said prefix being transmitted by said mobile node from said second interface newly connected to said home agent; and

means where said home agent detects said vertical handoff flag in said trigger message and shifts a prefix, to which said second interface has been related before disconnection, to said second interface newly connected.

Further, to attain the above objects, the invention provides the vertical handoff method, when a mobile node having interfaces connectable respectively to a first network and a second network where a proxy mobile IP managed by a common management node is provided, said mobile node roams within said first network and said second network, and said second interface is disconnected from said second network and connected again to said second network, wherein said method comprises:

a step of transmitting a trigger message of the vertical handoff, including a vertical handoff flag to instruct whether a prefix being related to said second interface before disconnection to said first interface or to be set on said second interface, and said trigger message not including an identifier of said second interface, said trigger message being transmitted to said home agent from said second interface before said mobile node is connected again; and

a step of selectively setting a prefix where said home agent sets up the prefix relating to said second interface before disconnection to said first interface or said second interface according to said vertical handoff flag in said trigger message.

Also, to attain the above objects, the invention provides the vertical handoff method, where a packet of a first prefix related to said first interface is transferred to said second interface, when a mobile node having at least the interface connectable respectively to a first network and a second network, and a proxy mobile IP managed by a common management node is provided, said mobile node roams within said first network and said second network, wherein said method comprises:

a step of setting said first prefix to a home agent of said mobile node so that binding is performed to said second interface when said mobile node shuts down said first interface; and

a step of transferring a packet where said home agent transfers a packet destined to said first interface to said second interface according to said binding.

With the arrangement as described above, even in case the mobile node has two or more interfaces, it is possible to reduce the packet size of signaling to request the vertical handoff.

According to the invention, the mobile node has static vertical handoff rules. When the mobile node has three or more interfaces, it is possible to reduce the packet size of signaling to request the vertical handoff.

Also, according to the invention, even in case the mobile node has two or more interfaces, it is possible to reduce the packet size of signaling to request the vertical handoff.

### BRIEF DESCRIPTION OF THE DRAWINGS

FIG. 1 is a schematical drawing to show an example of a vertical handoff system and a communication sequence in a first embodiment of the invention;

FIG. 2 is a schematical drawing to show another arrangement of an optimization request message of FIG. 1;

FIG. 3A is a table to explain an example of format of the optimization request message of the vertical handoff shown in FIG. 1 (a case of L2 message);

FIG. 3B is a table to explain an example of format of the optimization request message of the vertical handoff shown in FIG. 1 (a case of a signaling packet having a new mobility extension header);

FIG. 3C is a table to explain an example of format of the optimization request message of the vertical handoff shown in FIG. 1 (a case of a BU message packet);

FIG. 4 is a flowchart to explain operation of a mobile node in the first embodiment of the invention;

FIG. 5 is a schematical block diagram functionally showing an arrangement of a mobile node of the first embodiment;

FIG. 6 is a flowchart to explain operation of LMA/HA in the first embodiment;

FIG. 7 is a schematical block diagram functionally showing an arrangement of LMA/HA in the first embodiment;

FIG. 8 is a schematical drawing to explain an example of a vertical handoff system and a communication sequence of a fourth embodiment of the invention;

FIG. 9 is a flowchart to explain operation of a mobile node in the fourth embodiment;

FIG. 10 is a schematical drawing to show an example of a vertical handoff system and a communication sequence of a fifth embodiment of the invention;

FIG. 11A is a drawing to show arrangement of an example of a vertical handoff system in a sixth embodiment of the invention;

FIG. 11B is a schematical drawing to show an example of a communication sequence in FIG. 11A;

FIG. 12A is a schematical drawing to explain various cases of the vertical handoff (an example in case where the mobile node has two interfaces);

FIG. 12B is a schematical drawing to explain various cases of the vertical handoff (another example of a case where the mobile node has two interfaces);

FIG. 12C is a schematical drawing to explain various cases of the vertical handoff (an example of a case where the mobile node has three interfaces);

FIG. 12D is a schematical drawing to explain various cases of the vertical handoff (another example of a case where the mobile node has three interfaces);

FIG. 13 is a schematical drawing to show an example of a vertical handoff system as assumed in the first embodiment;

FIG. 14 is a schematical drawing to show another example of a vertical handoff system as assumed in the first embodiment; and

FIG. 15 is a schematical drawing to explain an example of a vertical handoff trigger message shown in FIG. 13.

### DESCRIPTION OF EMBODIMENTS

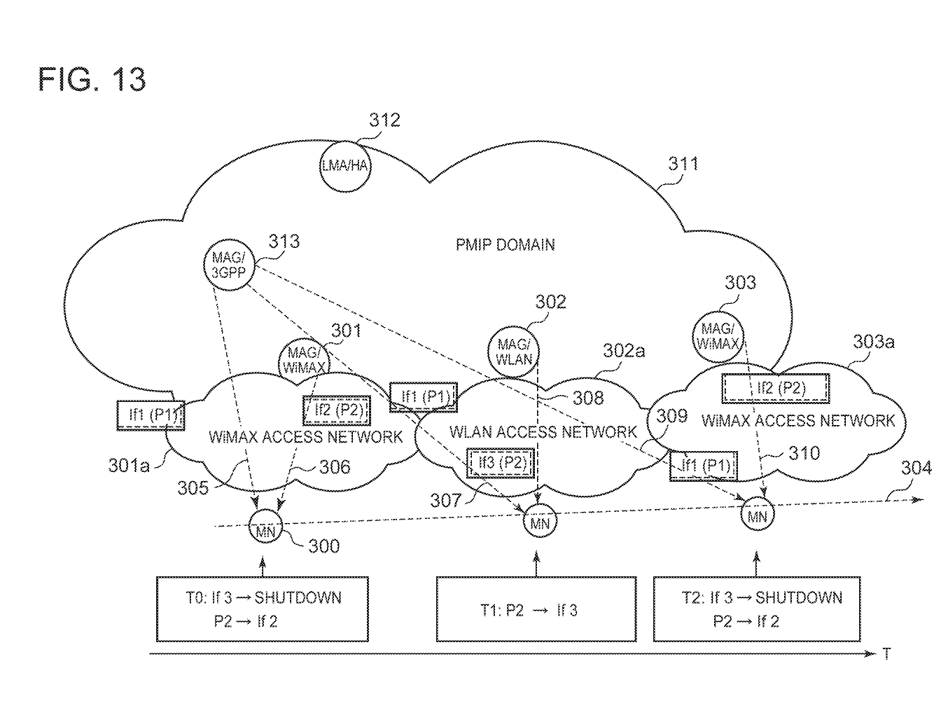

Description has already been given on problems in the vertical handoff in case there are three interfaces. Basically, when there are three or more interfaces, it is essential to have ID of the interface to shut down for accomplishing the vertical handoff. Description will be given below on problems in the process of the vertical handoff by referring to FIG. 13. Also, description will be given on an example of an operation scenario as assumed in the embodiment of the invention;

### An Example Based on Assumption

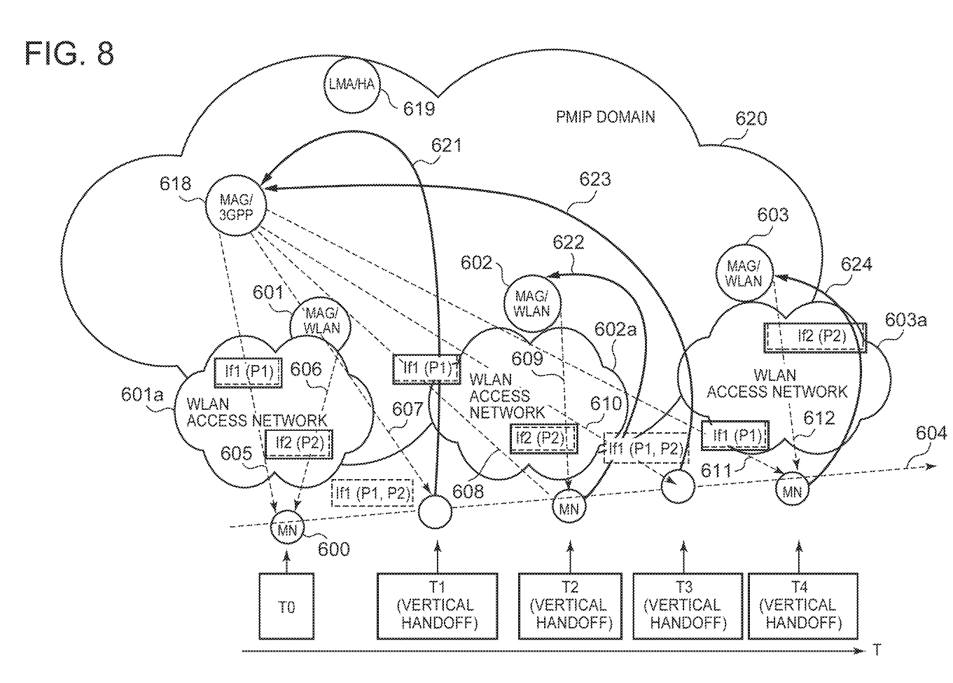

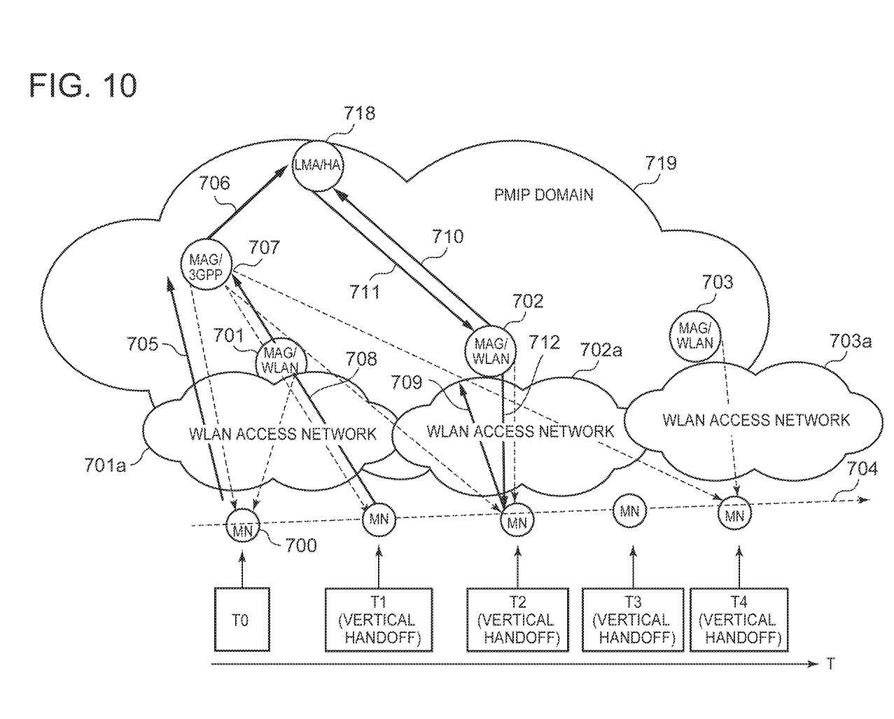

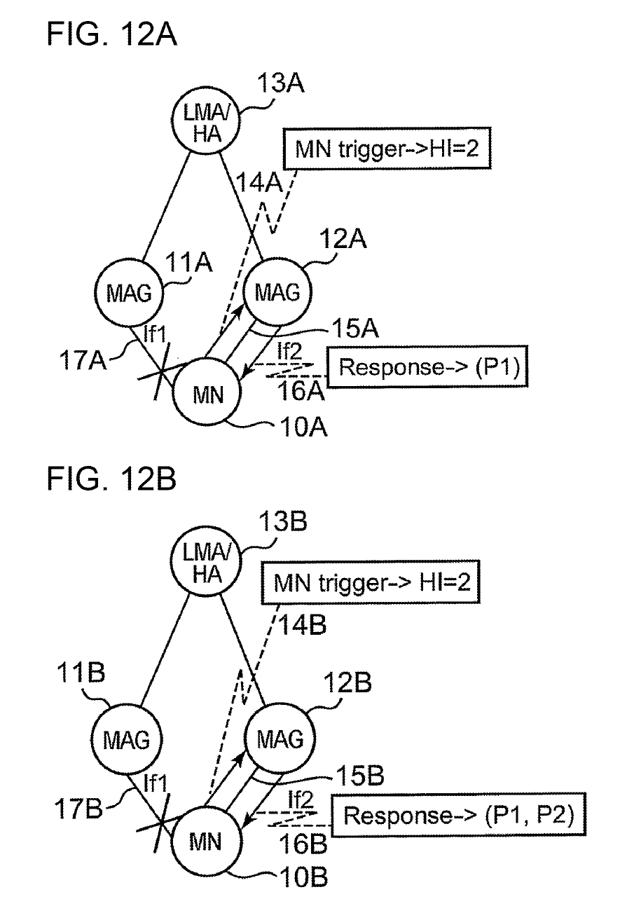

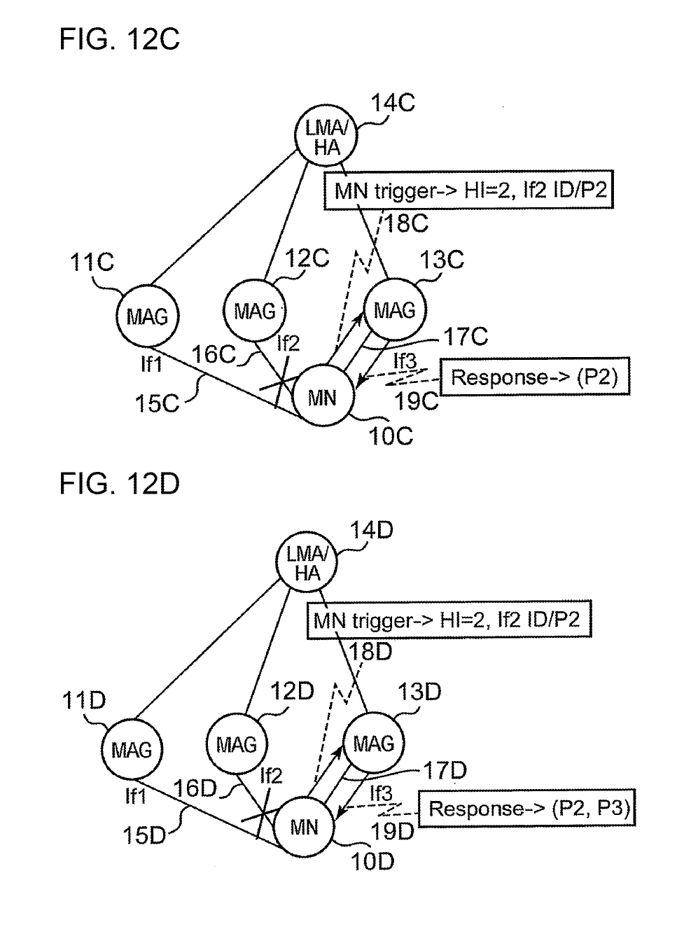

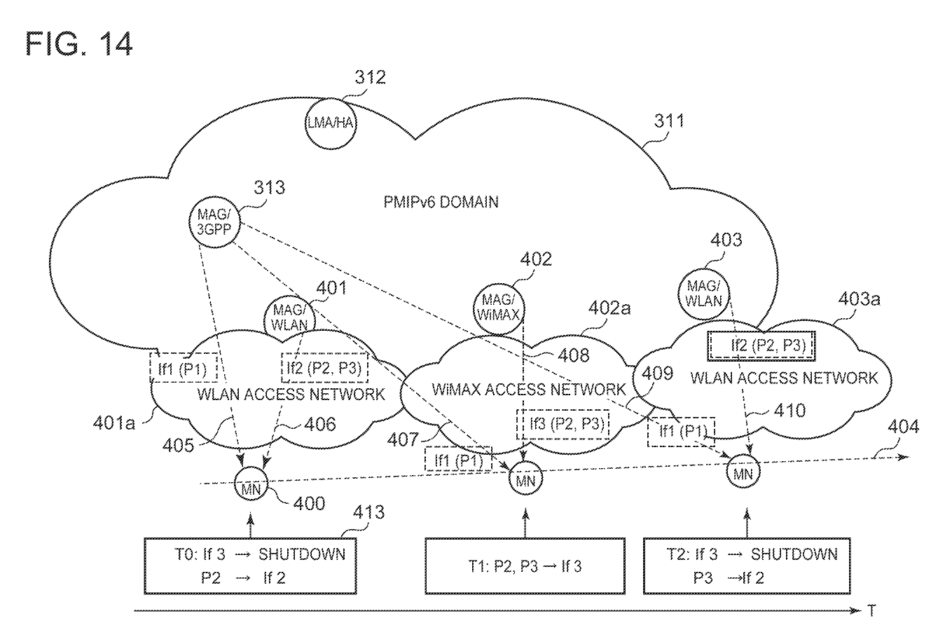

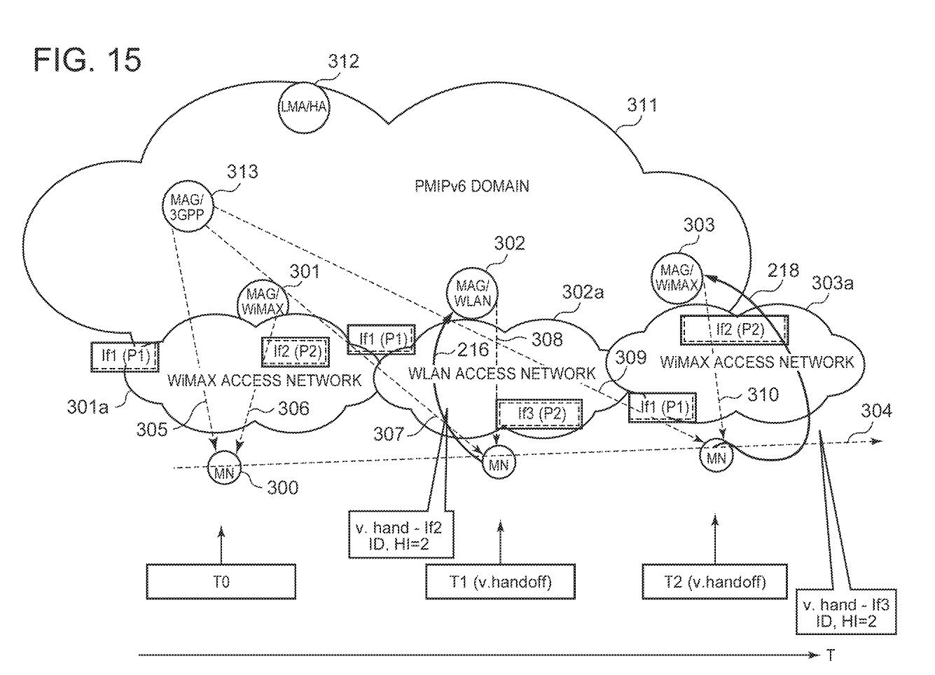

FIG. 13 shows a communication system as assumed in the first embodiment of the invention. FIG. 13 is a drawing to explain problems relating to vertical handoff in a PMIPv6 domain 311. In the PMIPv6 domain 311, a protocol of PMIPv6 is adopted in a local domain of 3GPP system architecture evolution (SAE). Description has already given, in connection with FIG. 12C and FIG. 12D, on the vertical handoff in case MN 300 has three interfaces If1, If2 and If3. To accomplish the vertical handoff, MN 300 must give an identifier of the interface to shut off to LMA/HA 312. While MN 300 is roaming in the PMIPv6 domain 311, many vertical handoffs are generated. In FIG. 13, and also, in FIG. 14 and FIG. 15 as given below, a cellular network a WLAN access network and a WiMAX access network are used for convenience. However, there is no limitation to an arrangement of the network, to types of access networks and to types and the number of interfaces shown in FIG. 13, and any arbitrary arrangement can be conceived in so far as it is not departed from the scope of the present invention. The same applies to the drawings (FIG. 8 and FIG. 10) of the communication system as used in the second embodiment and after.

Further, in FIG. 13, events of the vertical handoff occur due to three elements. The first element is that the network of the same access technology type is lacking, e.g. the cells of the WiMAX access networks 301a and 303a, with which the WiMAX interface If2 performs communication, and are continuous to each other. Also, a WLAN access network 302a, with which the WLAN interface If3 performs communication, is not continuous with the cell of the other WLAN access network. The second element is that it is wished to maintain a plurality of interfaces so that MN 300 can accomplish multi-homing. For instance, when the cellular interface If1 is connected, and when either one of the WiMAX interface If2 or the WLAN interface If3 is newly connected to the network, one or more arbitrary connections among a plurality of connections, which have been established in the cellular interface If1, selectively transferred either to the WiMAX interface If2 or to the WLAN interface If3. The third element is that MN 300 wishes to have a certain access technology type on a certain flow. Detailed description will be given below on the rules of the vertical handoff.

In FIG. 13, it is assumed that MN 300 has a 3G cellular interface If1, a WiMAX interface If2 and a WLAN interface If3. Also, it is assumed that LMA/HA 312 is an anchor point of the PMIPv6 domain 311. Further, it is assumed that a wireless access portion of the PMIPv6 domain 311 is fully covered by 3G cells, and routing of the PMIPv6 domain 311 is performed at the LMA/HA 312. Also, it is assumed that 3G cells are continuous to each other, and a WLAN access network (hereinafter referred as “WLAN domain”) 302a and WiMAX access networks (hereinafter referred as “WiMAX domain”) 301a and 303a are present within the scope covered by the PMIPv6 domain of the 3G cell. Basically, it is assumed that the PMIPv6 domain 311 of 3G cell is continuous, and that the WiMAX domains 301a and 303a and the WLAN domain 302a are not continuous to each other.

The assumptions as described above are quite possible. The reasons are as follows: MN 300 is attached to the PMIPv6 domain 311 of the 3G cell via the 3G cellular interface If1, but it is difficult to continuously arrange the cells in cooperation with a non-3GPP network because an operator different from the PMIPv6 domain 311 or an external operator offers a non-3GPP network (the WiMAX domains 301a and 303a and the WLAN domain 302A), and MN 300 may not be continuously attached to the non-3GPP network.

At the initial time point T0, a 3G cellular interface If1 of MN 300 is attached to an MAG/3GPP 313, and a WiMAX interface If2 is attached to MAG/WiMAX 301. As a result, MN 300 receives router advertisement (RA) messages 305 and 306 from the MAG/3GPP 313 and the MAG/WiMAX 301 respectively. For instance, MN 300 refers to prefixes P1 and P2 via the RA messages 305 and 306. Also, MN 300 refers to the prefixes P1 and P2 respectively via the RA messages 305 and 306. It is assumed that MN 300 wishes multi-homing to use two interfaces If1 and If2 at the same time and actually uses the two interfaces If1 and If2.

Next, MN 300 is moved, and at the time point T1, there is no range covered by the WiMAX domain 301a, and there remains only the range covered by the WLAN domain 302a. At this time point T2, MN 300 must carry out vertical handoff via the WLAN interface If3 in order to accomplish the multi-homing. The multi-homing in this case means that a plurality of interfaces are always used in case it is possible to attain higher band. Instead of this, at the time point 2, MN 300 may carry out the vertical handoff to WLAN, hoping that it can refer to a flow relating to the prefix P2 in WiMAX or WLAN access technology type. The important point to be understood in this case is that those skilled in the art would not naturally execute the vertical handoff to the MAG/3GPP 313 when it is not connected to the MAG/WiMAX 301 any more. The reason for this is that MN 300 wishes to use a plurality of interfaces, and it further wishes to transmit and receive the flow relating to the prefix P2 via WiMAX or via WLAN.

It is assumed here that MN 300 offers information of the WiMAX interface If2 via the WLAN interface If3 and refers to the prefix P2. In this case, at the time point T1, MN 300 refers to the prefixes P1 and P2 via RA messages 307 and 308 from the MAG/3GPP 313 and the MAG/WLAN 302 respectively. At the time point T1, the vertical handoff operation relating to the 3G cellular interface If1 is not performed. An important point to be understood in this case is that, it is desirable that the 3G cells are continuous, and that the flow to use the prefix P1 (e.g. VoIP) is preferably via the 3G cellular interface If1, and the vertical handoff of the prefix P1 is not needed.

At the next time point T2, it is assumed that MN 300 is deviated from the range of the WLAN domain 302a and has entered the range of the WiMAX domain 303a. However, it is still within the range of PMIPv6 domain 311 of 3G. In this case, it is assumed that the WLAN interface If3 loses the connection with the WLAN domain 302a, and that MN 300 wishes to be connected to the WiMAX domain 303a by using the WiMAX interface If2. At the time point T2, MN 300 must execute the vertical handoff to the MAG/WiMAX 303 and wishes to refer to the prefix P2 via the WiMAX interface If2. In this case, MN 300 transmits a trigger message of the vertical handoff (description is given in connection with FIG. 15) to the MAG/WiMAX 303. Basically, in the assumption as shown in FIG. 13, there is no problem relating to the prefix P1. The reason is that the PMIPv6 domain 311 is a big cell and in a continuous coverage range, and that the prefix P1 is referred via the 3G cellular interface If1 (RA messages 305, 307 and 309 in the figure). Only the prefix P2 is given and taken between the WiMAX interface If2 and the WLAN interface If3.

### Another Example Based on Assumption

The network arrangement shown in FIG. 14 is approximately the same as the one shown in FIG. 13, except that MN 400 has the 3G cellar interface If1, the WLAN interface If2, and the WiMAX interface If3. Moving locus of MN 400 is given as: WLAN access network 401a (time point T0)->WiMAX network 402a (time point T1)->WLAN access network 403a (time point T2). Although not shown in the figure, prior to the initial time point T0, MN 400 assumes that the 3G cell interface If1 refers to the prefix P1, the WLAN interface If2 refers to the prefix P2, and the WiMAX interface If3 refers to the prefix P3. At the initial time point T0, MN 400 moves to WLAN access network 401a apart from the range covered by the WiMAX network (not shown) and executes the vertical handoff to the interface If2. As a result, MN 400 refers to the prefix P1 via an RA message 405, and the interface If2 refers to the prefixes P2 and P3 via an RA message 406.

At the initial time point T0, as shown by the state 413, MN 400 shuts down the interface If3 and performs the vertical handoff of the flow of the prefix P3 to the MAG/WLAN 401 of the WLAN interface If2. Basically, MN 400 performs the vertical handoff to an interface as desired (to the WLAN interface If2 in this case), but the WLAN interface If2 is an interface already connected. Therefore, MN 400 refers to two prefixes P2 and P3 via the RA message 406 from the MAG/WLAN 401. The 3G cellular interface If1 refers to the prefix P1 continuously even at the initial time point T0 from the time prior to the initial time point T0.

It is assumed here that MN 400 moves further and loses the connection with the WLAN access network 401a and it is moved to the WiMAX network 402a, to which it has been connected at the time prior to the initial time point T0. It is also assumed that, at the time point T1, MN 400 performs the vertical handoff to the MAG/WiMAX 402, and not to the MAG/3GPP 313. In this vertical handoff operation, MN 400 must notify the identifier of the WLAN interface If2 or the prefixes P2 and P3 to MAG/WiMAX 402 via a vertical handoff trigger message (FIG. 15). When the vertical handoff has been successfully performed, MN 400 receives the RA message 408 from the MAG/WiMAX 402 and refers to the prefixes P2 and P3. Also, MN 400 receives the RA message 407 from the MAG/3GPP 313 and continuously refers to the prefix P1. It is supposed here that no vertical handoff operation is performed to the prefix P1, and that MN 400 wishes to send the prefix P1 via the 3G cellular interface If1 and does not wish to perform the vertical handoff operation on the 3G cellular interface If1.

Next, MN 400 moves further and is attached to the WLAN access network 403a at the time point T2 and loses the connection with the WiMAX network 402a. Also, at the time point T2, MN 400 executes the vertical handoff operation. The vertical handoff trigger message in this case also includes information relating to the WLAN interface If3. Basically, in this example based on assumption, there is no need to carry out the vertical handoff for the prefix P1 because the ranges covered by the 3G cells are continuous, and the vertical handoff operation is carried out on the prefixes P2 and P3.

FIG. 15 shows vertical handoff trigger messages 216 and 218 in FIG. 13. In case of MN 300 at the initial time point T0, the 3G interface If1 is attached to the MAG/3GPP 313, and the WiMAX interface If2 is attached to the MAG/WiMAX 301. At the next time point T1, the WiMAX interface If2 loses the connection with the MAG/WiMAX 301, and the WLAN interface If3 discovers the MAG/WLAN 302. It is supposed here that, at the time point T1, MN 300 wishes to refer to the prefix P2 via the WLAN network, and not via the 3G network. In order to refer to the prefix P2 via the WLAN interface If3, MN 300 must notify ID of the WiMAX interface If2 (If2-ID) or the prefix P2 and HI=2 as a trigger message 216 destined to the MAG/WLAN 302.

Similarly, MN 300 moves further, and, at the time point T2, the WLAN interface If3 loses the connection with the MAG/WLAN 302, and the WiMAX interface If2 discovers the MAG/WiMAX 303. At the time point T2, when MN 300 wishes to have the prefix P2 not via the 3G network but via the WiMAX network, ID of the WLAN interface If3 (i.e. If3-ID) and HI=2 must be notified via a trigger message 218 destined to the MAG/WiMAX 303.

In FIG. 15, when the vertical handoff is performed, a major problem is that trigger messages 216 and 218 having an interface identifier as long as 64-bit or the prefix must be continuously transmitted. In the following, an identifier of the interface, serving as the origin of the handoff, is notified as information to specify the prefix for the vertical handoff, while the prefix itself, which is an object of the vertical handoff, may be used instead of the interface identifier. The interface identifier as such increases packet sizes of the trigger messages 216 and 218, and further, increases power consumption of MN 300 or signaling cost of MN 300 when the trigger messages 216 and 218 are transmitted. Further, the more the packet sizes of the trigger messages 216 and 218 are increased, the wider wireless band must be used. Further, the identifier of interface to be shut down is needed within the PBU message to transmit parameters of the vertical handoff, and this means that signaling load of the core network is increased. Therefore, inconveniences may occur in case MN 300 has three interfaces of If1, If2 and If3, and the vertical handoff must be continuously performed by a fixed wish, i.e. by a static wish.

An important point in this case is that the patterns of the vertical handoff in FIG. 13 and FIG. 15 are very static. Specifically, MN 300 always wishes that the flow of the prefix P2 would pass via WLAN or via WiMAX. Basically, the rules of the vertical handoff are static so far as it is related to MN 300, and it is desirable that the trigger messages 216 and 218 to be continuously transmitted are optimized.

As the prior art, it is described in the Patent Document 1, that its purpose on the handoff, which is mainly a horizontal handoff, is to reduce the delay of the handoff. The mechanisms described in the Patent Document 1 comprise two elements. The first is to accelerate pre-authentication of the target in IEEE 802.11 network. The second point is to carry out virtual soft handoff prior to the attachment of the access router, which is the target. This is another type of optimization, which reduces the delay of the handoff, and it is not useful for the reduction of packet size of signaling in the vertical handoff. Also, even when it is applied to the vertical handoff, it simply reduces the delay of the vertical handoff.

As another prior art, the purpose of the method described in the Patent Document 2 is to improve the performance between different states of operation relating to a node, which has a plurality of interfaces. Basically, when MN is moving, packet loss during the handoff is monitored. Power is turned on for an adequate interface, and the packet loss is decreased. It is supposed here that a new interface receives the packet, which is brought to the interface in the vertical handoff, and the packet loss is decreased. However, even when this method is applied to the PMIPv6 domain, it is necessary that the vertical handoff occurs or the MAG where the new interface is connected must be able to receive the flow, which comes to another interface where the horizontal handoff is being executed. The purpose of the Patent Document 2 is to prevent the packet loss, and it is not the target to optimize the packet size of signaling in the vertical handoff.

As another prior art, the Patent Document 3 describes that the signaling from MN to AR (access router) is decreased during the connection of MN with the access router and during the handoff. It appears that this method is characterized by the means to optimize the delay of the handoff by reducing the packet size during the initial attachment and during the handoff attachment. However, signaling must be made from MN to AR at each time of connection. In contrast, the purpose of the object of the present invention is to remove information, which can be omitted during the signaling of the vertical handoff. As described above, when MN has static vertical handoff rules and it has three or more interfaces, it is evident that the continuation of the signaling of normal vertical handoff is not efficient.

Referring to the drawings, description will be given below on embodiments of the invention.

### The First Embodiment

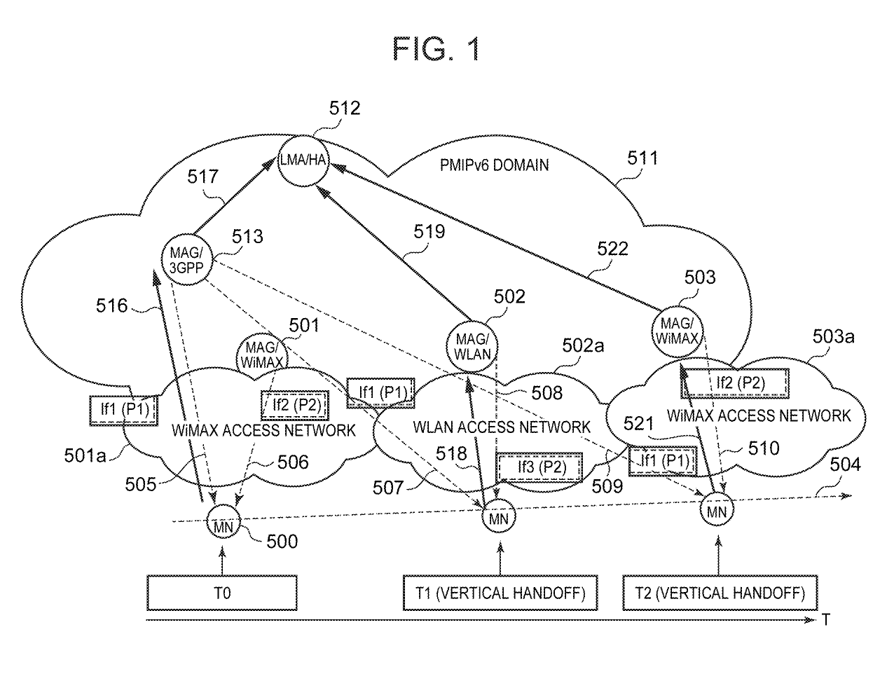

First, general features of the first embodiment will be described. When it is known that the rules of the vertical handoff of its own to the prefix of MN are static, a rule that this prefix should be uniquely used is preset to LMA/HA directly or via a proxy agent. MN transmits a trigger message of the vertical handoff having no interface identifier even when MN has three or more interfaces, and the packet size of the trigger message is decreased. FIG. 1 shows an example of a vertical handoff system and a communication sequence of the first embodiment. The network arrangement shown in FIG. 1 is the same as those shown in FIG. 13 and FIG. 15, and detailed description is not given here. In FIG. 1, it is supposed that MN 500 has three interfaces: a 3G cellular interface If1, a WiMAX interface If2 and a WLAN interface If3. MN 500 notifies the vertical handoff rules of MN 500 relating to the prefix, which is uniquely used between the WiMAX domain and the WLAN domain (hereinafter referred as “floating prefix”) to the MAG/3GPP 513 (516 in the figure). This information is transferred from the MAG/3GPP 513 to the LMA/HA 512 (517 in the figure). The vertical handoff rules may be notified when MN 500 is connected to the MAG/WiMAX 501 or the MAG/WLAN 502.

<Time Point T0>

At the initial time point T0 (state 513), MN 500 assumes that the 3G cellular interface If1 is attached to the MAG/3GPP 513 of the PMIPv6 domain 511 and that the WiMAX interface If2 is attached to the MAG/WiMAX 501 of the PMIPv6 domain 511 via the WiMAX access network 501a. It is also supposed that MN 500 refers to the prefix P1 by the RA message 505 via the interface If1 and refers to the prefix P2 by the RA message 506 via the interface If2. Here, it is assumed that MN 500 wishes to set up the fixed vertical handoff rules to the prefixes P1 and P2. Basically, MN 50 wants to refer to the prefix P2 only via the WiMAX access networks 501a and 503a and via the WLAN access network 502a. This request may depend on the property of the flow, which uses the prefix P2.

In this respect, at the initial time point T0, MN 500 transmits an optimization request message 516 (and 517) of the vertical handoff information to the LMA/HA 512 via the MAG/3GPP 513. The optimization request message 516 destined to the MAG/3GPP 513 may be a layer 2 (L2) message or may be a layer 3 (L3) message. By the optimization request message 516 (and 517), it is notified to the LMA/HA 512 that the prefix P2 is uniquely used as a floating prefix via the WiMAX access networks 501a and 503a and via the WLAN access network 502a.

Basically, the significance of the optimization request message 516 (and 517) is that, when the prefix P2 is transferred from the binding side WLAN to the binding side WiMAX, and when the vertical handoff is triggered from the WLAN side, the prefix P2 is transferred from the binding side WiMAX to the binding side WLAN. MN 500 predicts that, when it is roaming in the PMIPv6 domain 511 at the initial time point T0, such static vertical handoff can be carried out. If MN 500 cannot carry out static vertical handoff as such by this prediction, MN 500 returns to the standard vertical handoff of the PMIPv6 protocol, and the LMA/HA 512 acquires the processing method.

When the optimization request message 516 is received, the MAG/3GPP 513 notifies the contents of the optimization request message 516 to the LMA/HA 512 via another signaling message 517. The signaling message 517 may be a PBU message. When the signaling message 517 is received, the LMA/HA 512 recognizes that the prefix P2 is a floating prefix when the vertical handoff is executed between WiMAX and WLAN. To show this fact, a special flag is generated in its own binding cache.

<Time Point T1>

After transmitting the optimization request message 516, MN 500 moves along a locus 504, and it is disconnected from the MAG/WiMAX 501 and executes the vertical handoff to the MAG/WLAN 502. The vertical handoff trigger message 518 destined to the MAG/WLAN 502 in this case needs only the HI flag (=2; a value to indicate that it is handover connection), and there is no need to attach the identifier of the WLAN interface If2 and the prefix P2. This is because the optimization request message 516 at the time point T0 is already notified to the LMA/HA 512. Therefore, by the optimization request message 516 at the time point T0, it is known that the packet size of signaling of the vertical handoff at the time point T1 can be optimized.

When the vertical handoff trigger message 518 is received, the MAG/WLAN 502 transmits HI option (=2) and a PBU message 519 including ATT option to the LMA/HA 512. Upon receipt of the PBU message 519, the LMA/HA 512 checks whether MN 500 identified by NAI has a specific request to the floating prefix as referred by a specific access technology type (ATT) or not. When the PBU message 519 is received, the LMA/HA 512 identifies that the PBU message 519 has come from the network of the access technology type of the WLAN according to ATT option, and identifies that the prefix of the WiMAX must be transferred and further identifies the prefix P2. By a PBA message (not shown) to the PBU message 519, the prefix P2 is transferred to the MAG/WLAN 502. Therefore, MN 500 refers to the prefix P2 without giving information of the identifier of the WiMAX interface If3 in order to identify that the LMA/HA 512 indicates the prefix P2. As the time point T0, the 3GPP interface If1 of MN 500 establishes two connections (PDN (Packet Data Network) connections) by connecting to the MAG/3GPP 513, and the prefixes P1 and P2 may be assigned to each of the connections respectively. In this case, at the time point T0, for the purpose of indicating that the connection where P2 is assigned is a connection (floating connection) to be transferred to the WLAN interface If2 or the WiMAX interface If3 among the connections established in the 3G cellular interface If1, MN 500 registers the optimization request message including identification information (connection ID) associated with the connection where P2 is assigned via the MAG/3GPP 513 or directly at the LMA/HA 512. As the identification information a prefix as described in the present embodiment may be used. At the time point T1 and at the time point T2 to be described later, a vertical handoff trigger message is transmitted from the WLAN interface If2 or the WiMAX interface If3, and only the connection where the prefix P2 is assigned is transferred. Also, it may be so arranged that, during the procedure to establish the connection to the 3GPP network, the fact that the prefix P2 is a floating prefix to be used at the WLAN interface If2 and the WiMAX interface If3 may be notified to MN 500. When this notification is received, MN 500 judges that it is necessary to include the prefix P2 when the vertical handoff trigger message is transmitted via the WLAN interface If2 and the WiMAX interface If3. The scenario that a plurality of connections are established on the 3GPP interface If1 and that a specific connection among these is to be transferred to the WLAN interface If2 or the WiMAX interface If3 can also be applied to the second embodiment and the subsequent embodiments of the invention.

<Time Point T2>

When MN 500 is moved to the WiMAX access network 503a and receives the RA messages 513 and 510 from the MAG/3GPP 513 and the MAG/WiMAX 503 respectively, the operation is the same as described above, and MN 500 transmits the vertical handoff trigger message 518 with an HI flag (=2) only from the WiMAX interface If3 to the MAG/WiMAX 503, and the MAG/WiMAX 503 transmits a PBU message 522 including the HI flag and the ATT option to the LMA/HA 512. The processing of the LMA/HA 512 is the same as described at the time point T1, and detailed description is not given here. When the fixed and static vertical handoff rules as described above are not needed to its flow, MN 500 transmits an explicit message to delete such rules to the LMA/HA 512.

<Other Arrangement of the Optimization Request Message 516>

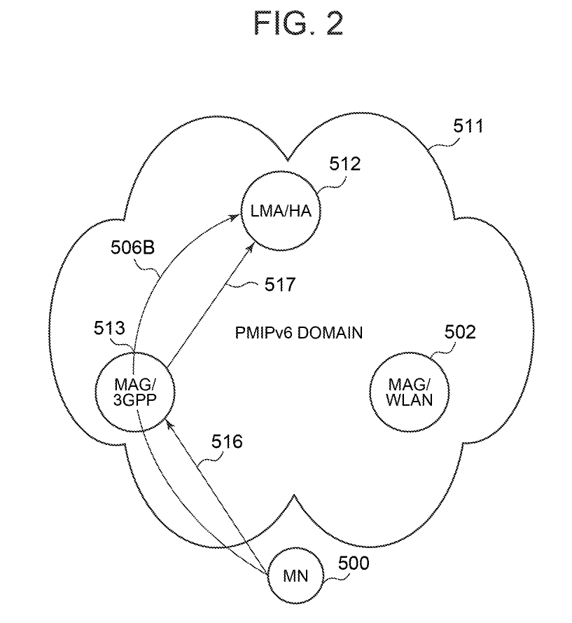

FIG. 2 shows: (1) an example of the optimization request message 516 of L2 and the PBU message 517 of L3, and (2) another example of the optimization request message 506B to be transmitted directly from MN 500 to the LMA/HA 512 as another example.

(1) The optimization request message 516 of L2 can be transmitted at the time of L2 association in the initial stage, and the signaling message 517 of L3 can be transmitted after L2 has been successfully established. The MAG/3GPP 513 has no need to refer to the floating prefix in the optimization request message 516 of L2, and the contents of the optimization request message 516 may be simply transferred to the LMA/HA 512 via the PBU message as the signaling message 517. In this case, the contents of the optimization request message 516 are embedded as mobility option of a new type of the PBU message 517, or the floating prefix and the access technology type are transmitted via a new field of header of a new mobility message. The optimization request message 516 may be RS (Router Solicitation) message, an NS (Neighbor Solicitation) message or a BU message or L3 message such as a BU message or an FBU (Fast Binding Update) message.

(2) As another arrangement, after MN 500 acquires the address of the LMA/HA 512 by making an inquiry to the MAG/3G 513. MN 500 transmits an optimization request message 506B directly to the LMA/HA 512 as shown in the figure. According to this method, the load on the processing of the MAG/3G 513 is slightly reduced. There is another method for MN 500 to acquire the address of the LMA/HA 512: a method, by which MN 500 makes inquiry to an AAA server (not shown). An important point to be understood here is that, when the 3G cellular interface If1 refers to the home prefix where MN 500 is located within the PMIPv6 domain of the home, this direct optimization request message 506B may be a message, which has a message extension header of a new mobility header. When MN 500 is located in an external domain, the message 506B may be a BU message having new option. Also, signaling such as IKE (Internet Key Exchange) or IPSec (IP security) to be given and taken to and from the LMA/HA may be used. For instance, this request may be notified in the attachment procedure to perform when the 3G cellular interface If1 is attached to the cellular network 511 or the procedure to update the attachment. Further, this request may be notified in the attachment procedure, which the WLAN interface If2 or the WiMAX interface If3 performs when these are connected to a non-3GPP network or during the attachment updating procedure. In another arrangement, when MN 500 has information relating to network traffic, another interface, e.g. the WLAN interface If2 or the WiMAX interface If3, may be selected, and this can be used as the interface to transmit the optimization request message 516.

The case shown in FIG. 2 where MN 500 can transmit the optimization request message 506B directly to the LMA/HA 512 is the case where the LMA/HA 512 is an MIPv6 home agent of MN 500 and MN 500 has address information of the LMA/HA 512. In case MN 500 does not have the address of the LMA/HA 512, MN 500 must acquire the address of the LMA/HA 512 by using the MAG/3GPP 513, to which it is attached, or by using the AAA server, DNS, etc. An important point to be understood in this case is that there is an effect by direct notification to the LMA/HA 512 only when the LMA/HA 512 is an MIPv6 home agent of MN 500. Even when LMA/HA 512 is not an MIPv6 home agent of MN 500, if MN 500 can use means and signaling to acquire the address of the LMA/HA 512, it may transmit the optimization request message 506B after acquiring the address of the LMA/HA 512 by using these. In case MN 500 has acquired the address of the LMA/HA 512, by giving notification to the LMA/HA 512, it is possible to decrease the load on the MAG/3GPP 513.

<Format of the Optimization Request Message>

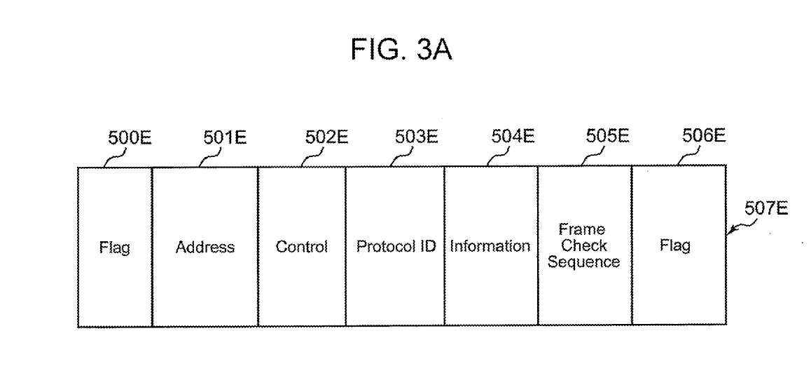

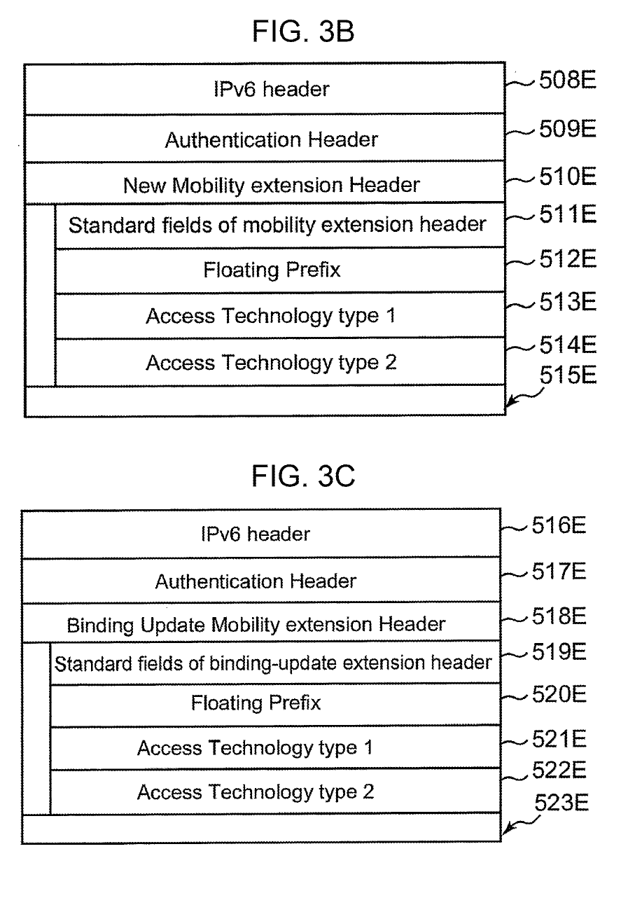

Referring to FIG. 3A, FIG. 3B and FIG. 3C, description will be given below on detailed arrangement examples of the optimization request messages 516 and 506B.

(a) A frame 507E as shown in FIG. 3A shows a frame structure when the optimization request message 516 is an L2 message, and it comprises the fields as given below sequentially from the head: a starting flag 500E, an address 501E, a control 502E, a protocol ID 503E, an information 504E, an FCS (Frame Check Sequence) 505E, and a termination flag 506E.

The starting flag 500E is a flag to show the head of the frame 507E. The address 501E of the second field is a MAC (Media Access Control) address, and source address and destination address of the L2 packet are included. For instance, the source address is a MAC address of the interface If1 of MN 500, and the destination address is the MAC address of ingress interface (not shown) of the MAG/3GPP 513. The control 502E in the third field is information to identify the type of the frame used, and it is important that the receiving side can correctly process the frame 507E of L2. Basically, the control 502E is used to identify the type of the frame 507E, i.e. the type of the optimization request message 516.

The protocol ID 503E in the fourth field is a value relating only to the packet, which is generated in an upper layer. When the message 517 is generated on L2, all are 0. However, even when the message 516 is generated at L2, the decision to transmit the message 516 and the related parameters embedded in the message 516 must come from L3. The information 504E of the next field contains a floating prefix to be uniquely used at the time of the vertical handoff and also includes the access technology type (e.g. identifier of WiMAX or WLAN). After the information 504E, the field of the FCS 505E follows. FCS 505E is a frame check sequence field, and it is calculated by the transmitting side and the receiving side in order to confirm whether the frame 507E is transmitted without error (i.e. error is identified or corrected). The termination flag 506E in the last field is basically used to identify the termination of the frame 507E as a delimiter of the frame 507E. In this case, there is no need that the structure of the frame 507E is the same as the structure shown in FIG. 3A as far as it is not departed from the scope of the invention. Further, an L3 message may be used instead of the L2 message shown in FIG. 3A as the optimization request message 516 as far as it is not departed from the scope of the invention. For instance, it may be an NS (Neighbor solicitation) message or an RS (Router Solicitation) message, or further, an IKEv2 message including a message of mobility header (a BU message of mobility header of new type). In case it is a message including the mobility header, the structure as shown in FIG. 3B or FIG. 3C may be used.

As described above, MN 500 can transmit a packet to transmit the optimization request message 516 by L3 (506B in FIG. 2). When the signaling of L3 is used, MN 500 can use a new mobility extension header of a BU message with mobility option.

(b) FIG. 3B shows a signaling packet 515E, which has a new mobility extension header 510E. Detailed description will be given below on the packet 515E. The first header of the packet 515E is a standard IPv6 header 508E. The IPv6 header 508E includes source address where HoA or CoA of MN 500 is set and a destination address when the address of the LMA/HA 512 is set. The next header of the packet 515E is an authentication header 509E, and it has authentication data signed by the security key, which is exchanged between MN 500 and the LMA/HA 512. The header 509E is a desirable field, but it is not essential.

The third header is the new mobility extension header 510E. The header 510E first has a standard field of mobility extension header 511E, and the standard field of mobility extension header 511E contains protocol number, mobility header type, checksum, etc. The new mobility extension header 510E further contains three standard fields 512E, 513E and 514E. The first field (floating prefix) 512E shows a floating prefix, which is used uniquely at the time of the vertical handoff. If there are a number of floating prefixes, the field 512E will be larger. However, in case there are a plurality of floating prefixes, a field to indicate the number of the prefixes should be within the message. The next field (access technology type 1) 513E shows a first access technology type (WLAN) at the time of the vertical handoff. The third field (access technology type 2) 514E shows a second access technology type (WiMAX) at the time of the vertical handoff. It should be emphasized here that there are many methods to arrange the fields of the new mobility extension header 510E. Here, however, description will be simply given on a packet 515E, which is a desirable method.

(c) FIG. 3C shows a third example to transmit the optimization request message, presenting the structure of a packet 523E of the BU message. Similarly to the case shown in FIG. 3B, the first header of the packet 523E is an IPv6 header 516E, and the next header is preferably an authentication header 517E. After the authentication header 517E, the BU mobility extension header 518E follows. The first field of the header 518E is a standard field of a binding update extension header 519E, and for instance, it contains all standard fields in BU such as the period of existence, sequence number, etc.

After the standard BU extension header 519E, there are provided a new option field (floating prefix) 520E, “an access technology type 1” 521E, and “an access technology type 2” 522E. Similarly to the case shown in FIG. 3B, the first option field (floating prefix) 520E shows a floating prefix to be used uniquely at the time of the vertical handoff. The second option field “access technology type 1” 521E shows a first access technology type (WLAN) at the time of the vertical handoff, and the third option field “access technology type 2” 522E shows the second access technology type (WiMAX) at the time of the vertical handoff. It is not necessary that there are two ATT fields, which are included to indicate the interface where the floating prefix is applied. When there is only one interface to be applied, only one ATT field is included. In case it is applied to three or more interfaces, three or more ATT fields are included.

<Operation of MN>

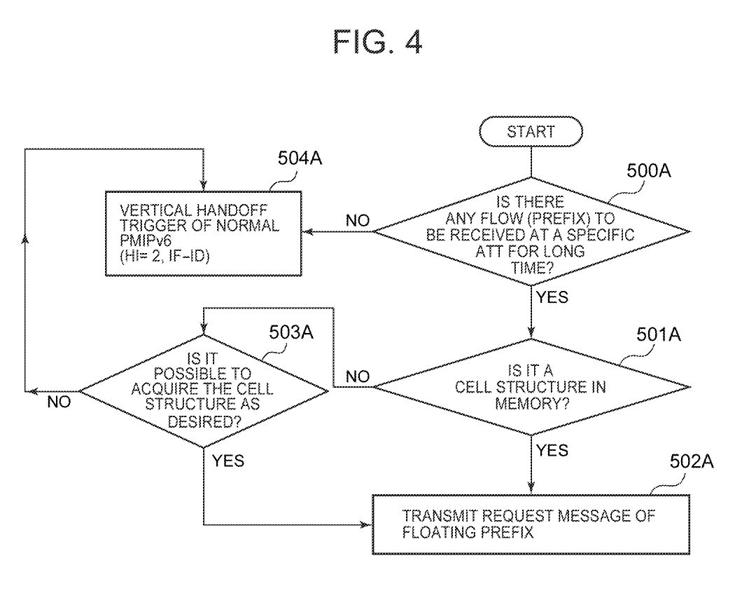

Next, referring to FIG. 4, description will be given on operation of MN 500. First, MN 500 checks whether or not there is a specific flow (prefix) to be received for a certain predetermined time period via a specific access technology type (ATT) in Step 500A. If the answer is “No”, it is branched off to Step 504A, and the vertical handoff or normal PMIPv6 is carried out, and HI=2 and the vertical handoff trigger message including HI=2 and the identifier (If-ID) of the interface for the vertical handoff are transmitted.

On the other hand, if the answer is “Yes” in Step 500A, it is advanced to Step 501A, and before transmitting the optimization request message 516 as described above, it is checked whether it is possible or not to refer to the prefix via the ATT (WLAN and WiMAX) as desired. When MN 500 stores the information of cell structure (such as the information of the network connected earlier) relating to the domain in connection is kept in memory, MN 500 may carry out the checking as described above by referring to the information on the cell structure in Step 501A. If the answer is “Yes”, it is advanced to Step 502A, and the optimization request message 516 to notify the floating prefix is transmitted, and the process operation is terminated. In this case, the floating prefix is notified via a stable connection interface of MN 500.

The procedure in Step 501A is not necessarily performed. Also, when a notification to request the selection of the floating prefix is received from a network entity such as the LMA/HA 512 or the AAA server, etc., as a trigger to start the step 500A, the prefix to be referred at a specific ATT may be selected from among the prefixes maintained by MN 500 in Step 500A. Also, when the vertical handoff operation to move a specific prefix occurs more than a predetermined number of times among the prefixes maintained by MN 500, this prefix may be selected as the floating prefix. Further, in case the access networks are complementary to each other, a prefix may be selected, which is moved between these access networks, and this prefix may be registered as a floating prefix. Further, when a floating prefix is explicitly notified from the LMA/HA 512 or the AAA server and it is judged that this prefix should be used as the floating prefix, it may be decided that the result of the judgment is notified as a message to transmit as the optimization request message 516. Or, the floating prefix may be selected, depending on the frequency of the moving or on the connecting condition of MN 500. In this case, if the number of handover operation within a certain time period (number of transmissions of the vertical handoff trigger message 518) exceeds the predetermined number of times, it may be judged that the floating prefix is selected, and the optimization request message 516 may be transmitted. As a result, it is possible to reduce the packet size of the vertical handoff trigger message 518, which has high transmission frequency.

On the other hand, if the answer is “No” in Step 501A, it is branched off to Step 503A, and it is checked whether it is possible or not to acquire the information of cell structure as described above from the LMA/HA 512 or a MIH (Media Independent Handoff) server. If the answer is “Yes”, it is advanced to Step 502A, and the optimization request message 516 to notify the floating prefix is transmitted. In this case, an important point to be understood is that the judgment of MN 500 in Step 503A should be based on some type of information, which has been arranged already. For instance, MN 500 may have a type of information, which relates to a domain having the MIH server. Also, in such domain, the LMA/HA 512 may have a type of information relating to the type of cell or cell structure. When the answer in Step 503A is “No”, it is branched off to Step 504A, and a normal vertical handoff trigger message of the PMIPv6 is transmitted.

<Arrangement of MN>

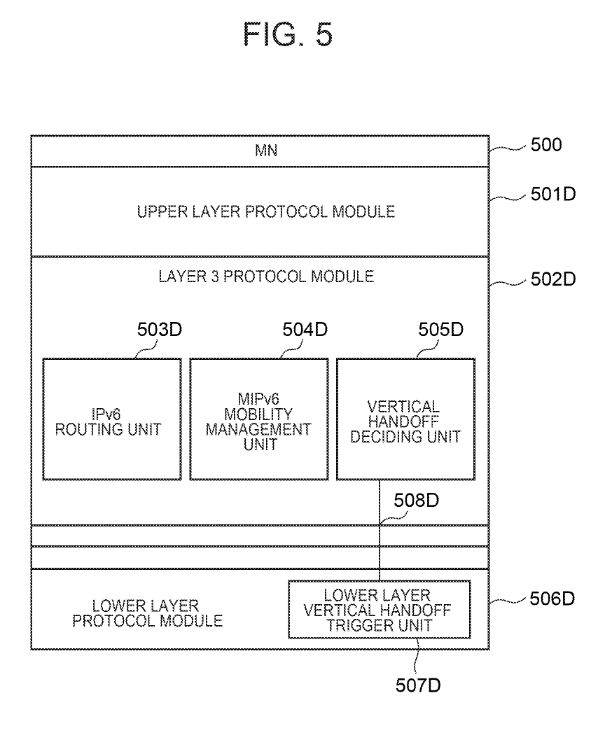

Next, referring to FIG. 5, description will be given on the arrangement of MN 500. FIG. 5 is a schematical block diagram to functionally show the arrangement of MN 500. Here, it is shown in FIG. 5 that MN 500 has an MIPv6 mobility management unit 504D, while MN 500 in the first embodiment can be applied to all types of MN including MN, which is merely an IPv6 host or which has a function to support multi-homing. Further, in case a prefix and intelligence of the flow relating to this prefix are given on the layer 2 protocol stack, this can be applied to the layer 2 without changing the layer 3.

MN 500 as shown in FIG. 5 indicates functional arrangement of the MIPv6 and it has three major modules: a lower layer protocol module 506D, a layer 3 protocol module 502D, and an upper layer protocol module 501D. The lower layer protocol module 506D has a plurality of lower layer protocol modules (not shown), which are directly related to the interface If1, If2 and If3 of MN 500, and the number of the modules is the same as the number of interfaces. Also, the lower layer protocol module 506D has the functions of all physical layers and the link layers necessary for basic data communication including signal modulation, coding, compression, media access control and link layer control of the interfaces If1, If2 and If3.

Further, the lower layer protocol module 506D has a lower layer vertical handoff trigger unit 507D, which supports the optimization request message 516 to assign the prefix for the vertical handoff between two different access technology types as the floating prefix. Basically, when the vertical handoff deciding unit 505D of the layer 3 decides the transmitting of the optimization request message 516 and the vertical handoff trigger message 518, these types of information and the related parameters are sent to the trigger unit 507D via the interface 508D. The layer to transmit the optimization request message 516 to the MAG/3GPP 513 is actually the layer 2 by the trigger unit 507D. Here, it is evident that the optimization request message may not necessarily be prepared on the layer 2, but it can prepared on the layer 3 so far as it is not departed from the scope of the invention. The trigger unit 507D transmits the optimization request message 516 including the information as decided as the layer 3 and the vertical handoff trigger message 518 directly to the MAG/3GPP 513. As destination addresses of the optimization request message 516 and the vertical handoff trigger message 518 to be transmitted from the trigger unit 507D, the link layer address of the MAG/3GPP 513 is used.

In case the vertical handoff trigger unit 507D is provided in the layer 3 protocol module 502D, a link local address of the MAG/3GPP 513 is set as destination address of the packet of the optimization request message 516, and it is sent to the lower layer protocol module 506D. In this case, major functions of the lower layer protocol module 506D are to encapsulate the packet by using the layer 2.

The layer 3 protocol module 502D has three sub-modules: an IPv6 routing unit 503D, an MIPv6 mobility management unit 504D, and the vertical handoff deciding unit 505D as given above. The IPv6 routing unit 503D, which fulfills the major functions, carries out packet routing, address arrangement, and neighbor discovery. The MIPv6 mobility management unit 504D is in charge of mobility management of one or more interfaces of MN 500. The vertical handoff deciding unit 505D decides prefixes for vertical handoff and necessary parameters transmitted via the optimization request message 516.

Also, the vertical handoff deciding unit 505D decides the transmission of a vertical handoff trigger message 518. More concretely, when the vertical handoff is carried out, it is confirmed whether or not the network, to which the interface for transmitting the vertical handoff trigger message 518 (i.e. the interface, which is the destination of handoff is network falling under the category of the access technology type as registered in the optimization request message 516. If it is the network as applicable, the vertical handoff trigger message 518 not including interface identifier of the interface used in the transmission is generated in the vertical handoff trigger message 518, and it is transmitted. On the other hand, if it is a network not falling under the category of the registered access technology type, the vertical handoff trigger message 518 including the interface identifier of the interface used for transmission is generated in the vertical handoff trigger message 518, and it is transmitted.

Describing in more detail, when there is an interface with its connection disconnected from the network or when there is an interface with its connection nearly disconnected from the network, the vertical handoff deciding unit 505D confirms whether the network, to which the interface is connected, is a network, which falls under the category of the access technology type as registered by the optimization request message 516. As a result, if it is the network falling under the above category, it is further confirmed whether there is an interface or not, which is connected to the other access technology type registered in the same optimization request message 516. If such interface is present, this interface is selected as the interface to be used for the transmission of the vertical handoff trigger message. Then, the vertical handoff trigger message 518 is generated, which does not include the interface identifier of the selected interface, and it is transmitted. On the other hand, if such interface is not present, an interface connected to the other network and not registered in the same optimization request message 516 is used, and the vertical handoff trigger message 518 including the interface identifier of this interface is transmitted.

According to another method, the vertical handoff deciding unit 505D decides, when there is an interface newly connected to the network or an interface, which is very likely to be connected newly, the network 505D confirms whether the network where the interface is connected, or a network where the interface is very likely to be connected is a network, which falls under the category of the access technology type as registered in the optimization request message 516. As a result, if it is a network, falling under such category, it is confirmed whether an interface is present or not, which is connected to other access technology type as registered in the same optimization request message 516. If such interface is present, the interface newly connected to the network is selected as an interface to be used for transmission of the vertical handoff trigger message. Then, a vertical handoff trigger message 518 not including the interface identifier of the selected interface is generated, and this is transmitted. On the other hand, if it is not present, an interface connected to the other network not registered in the same optimization request message 516 is used, and the vertical handoff trigger message 518 including the interface identifier of this interface is transmitted. The upper layer protocol module 501D executes the protocol of a transport layer or an application layer.

<Operation of LMA/HA>

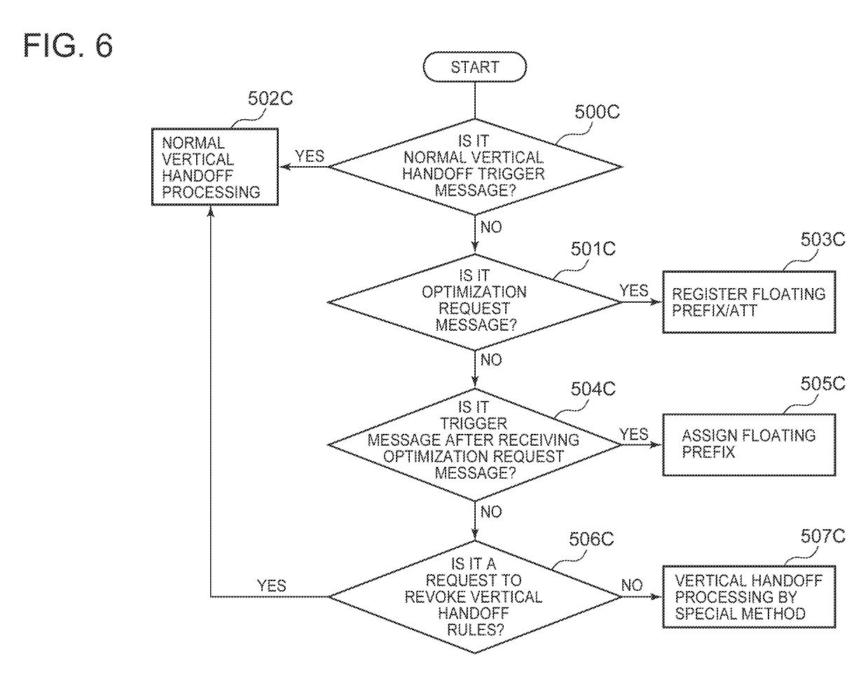

Next, referring to FIG. 6, description will be given on operation of the LMA/HA 512. When a PBU message from MAG is received, the LMA/HA 512 first carries out the processing of Step 500C. In Step 500C, it is checked whether or not this PBU message relates to a normal type vertical handoff trigger message where the vertical handoff rules registered to the LMA/HA 512 are not included. If the answer is “Yes”, it is branched off to Step 502C, and normal handoff processing is performed. Binding cache entry is checked, and the prefix relating to older interface of MN 500 is given to the new interface.

If the answer is “No” in Step 500C, it is advanced to Step 501C, and it is checked whether or not the PBU message is a new optimization request message including the static vertical handoff rules to the floating prefix. If the answer is “Yes”, it is branched off to Step 502C, and the floating prefix in the received message and access technology type (WLAN and WiMAC) are registered in the binding cache. In this case, for the purpose of registering the floating prefix and the access technology type, the LMA/HA 512 can generate a new field in the binding cache entry. However, how LMA/HA 512 registers it depends on the arrangement.

If the answer in Step 501C is “No”, it is advanced to Step 504C, and it is checked whether or not the PBU message is the vertical handoff trigger message after the static and fixed vertical handoff rules to the floating prefix by receiving the optimization request message. If the answer is “Yes”, it is branched off to Step 505C. In Step 505C, it is checked whether or not it is MN, for which the static and fixed vertical handoff rules were set up, and whether a binding of WiMAX corresponding to the vertical handoff triggered via WLAN is present or not. If the answer is “Yes” in all these cases, the floating prefix is assigned, which is to be uniquely used at the time of the vertical handoff between WLAN and WiMAX.

On the other hand, if the answer is “No” in Step 504C, it is advanced to Step 506C. Then, it is checked whether or not the PBU messages is a message to request the renunciation of the static and fixed vertical handoff rules. If the answer is “Yes”, the vertical handoff rules are revoked, and it is advanced to Step 502C, and the normal vertical handoff processing is carried out. If the answer is “No” in Step 506C, it is advanced to Step 507C, and the static vertical handoff processing based on a special method is carried out.

<Arrangement of LMA/HA>

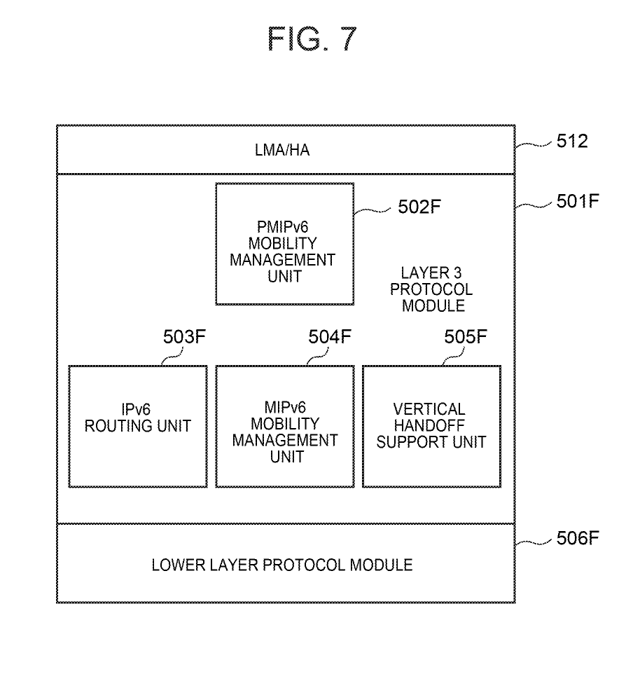

Next, referring to FIG. 7, description will be given on the arrangement of the LMA/HA 512. FIG. 7 is a schematical block diagram functionally showing the arrangement of the LMA/HA 512. The LMA/HA 512 has a layer 3 protocol module 501F and a lower layer protocol module 506F, which is a lower layer of the layer 3. The lower layer protocol module 506F has the functions of all of data-link layers and base band level. The layer 3 protocol module 501F has four sub-modules: a PMIPv6 mobility management unit 502F, an IPv6 routing unit 503F, an MIPv6 mobility management unit 504F, and a vertical handoff support unit 505F. In the figure, no interface is shown between these modules 501F and 506F and the units 502F, 503F, 504F and 505F, but the interfaces are present there.

The IPv6 routing unit 503F is in charge of performing mechanisms of the standard mechanisms of IPv6 such as packet routing, address arrangement, neighbor discovery, etc. The MIPv6 mobility management unit 504F is in charge of executing the mechanisms similar to those of the home agent of MIPv6. For instance, it fulfills the functions such as: processing of the BU message of CMIPv6, transmission of an ACK signal (a BA message) to the BU message, tunneling of data packet, maintenance of binding cache, etc. The PMIPv6 mobility management unit 502F basically fulfills the functions of LMA as disclosed in the PMIPv6 (the Non-Patent Document 2). The functions relating to the unit 502F are: processing of the PBU message having various types of options (such as HI option, access technology option, etc.), transmission of ACK signals (PBA message) to the PBU message, the processing of uplink packet and downlink packet from MN in the PMIPv6 domain. An important point to be understood here is as follows: The PMIPv6 mobility management unit 502F and the MIPv6 mobility management unit 504F have basically different functions respectively, but these are arranged in a single module, and it can be so designed that the PMIPv6 cache and the CMIPv6 cache can have a single binding cache. There are many methods to provide the units 502F and 504F, and there is no special restriction.

The vertical handoff support unit 505F as finally mentioned processes the optimization request message 516 and sets the results of processing on one or more floating prefixes relating to MN 500 to the PMIPv6 cache. Further, the unit 505F receives inquiries to assign the floating prefixes from the PMIPv6 mobility management unit 502F when the vertical handoff is carried out. The parameters in these inquiries are: the present access technology type of MN 500, the access technology type where the vertical handoff is triggered, the floating prefixes, etc. From these parameters, the unit 505F decides a prefix to be given during the vertical handoff and notifies it to the PMIPv6 mobility management unit 502F. Basically, the decision on the assignment of the floating prefixes is made by the vertical handoff support unit 505F, while the PBA message to notify the floating prefixes is under the control of the PMIPv6 mobility management unit 502F.

The first embodiment of the invention provides such effects that, after registering the prefixes to be continuously used in the optimization request message 516, MN 500 has no need to explicitly include the prefixes to be moved in the vertical handoff trigger message, which is transmitted when the vertical handoff is carried out.

### The Second Embodiment

Next, referring to the same FIG. 1, description will be given on the second embodiment of the invention. In the first embodiment, the LMA/HA 512 detects the static vertical handoff rules of MN 500 by the optimization message 516 from MN 500 and optimizes the packet size of the vertical handoff trigger message. According to the second embodiment, the LMA/HA 512 optimizes the packet size of the vertical handoff trigger message at its own judgment without receiving the optimization request message 516. In the second embodiment, the LMA/HA 512 takes note and learns at all times that the prefixes P2 are processed by the handoff via access technology type of WiMAX and WLAN. Further, it predicts the intention of MN 500 and notifies MN 500 that the identifier of the interface to be shut down should not be notified via the vertical handoff trigger message to MN 500. Basically, the LMA/HA 512 decides the static vertical handoff rules to be applied by its own decision and notifies it to MN 500. The static vertical handoff rules may be included in the information relating to MN 500 as maintained by information server. In this case, based on the information acquired from the information server, the LMA/HA 512 notifies the static vertical handoff rules to MN 500.

Major advantages of the second embodiment are that the processing of MN 500 (i.e. transmitting of the optimal request message 516) can be omitted.

### The Third Embodiment

Next, description will be given on the third embodiment. In the third embodiment, as shown in FIG. 1, MN 500 notifies the static vertical handoff rules (the optimization request message 516) to the MAG/WiMAX 501 or the MAG/3GPP 513, which are proxy nodes of MN 500, and MAG 501 or 513 transfers the rules to the other MAG 502 and MAG 503 via CT (context transfer). When it is decided to notify the static vertical handoff rules, MN 500 first notifies to the MAG/WiMAX 501, for instance. As described above, by the optimization request message 516, the prefix P2 is notified, which MN 500 wants to uniquely refer via WLAN or via WiMAX. In addition to the assumption to notify the information of the prefix P2 to the MAG/WiMAX 501, MN 500 further transfers identifier of the MAG/WLAN 502, which is the next access router (AR). The identifier of the next AR is an identifier similar to ESSID (Extended Service Set ID) of the WLAN. Therefore, the MAG/WiMAX 501 identifies the IPv6 address of the next MAG/WLAN 502 by using this identifier. Basically, the vertical handoff rules are not necessarily given continuously during the vertical handoff, but it must be given to the MAG/WiMAX 501, which has the next information on an older AR. Therefore, the packet size of the trigger message to be transmitted to the new MAG 502 and MAG 503 can be reduced, but it is not very useful that MN 500 transmits the information of the vertical handoff rules to the next MAG/WLAN 502. However, it is useful when the vertical handoff is established for perfect network control.

### The Fourth Embodiment

Next, referring to FIG. 8, description will be given below on the fourth embodiment of the invention. In the network arrangement shown in FIG. 8, MN 600 has two interfaces, i.e. a 3G cellular interface If1 and a WLAN interface If2. Also, it is supposed that WLAN access networks 601a, 602a and 603a, to which the WLAN interface If2 is attached, are not continuous when MN 600 moves along a locus 604. In this respect, it is assumed here that the WLAN interface If2 is attached to the WLAN access network 601a and the MAG/WLAN 601 at the time point T0, that the WLAN interface If2 loses connection with the WLAN access network 601a and the MAG/WLAN 601 at the time point T1, that it is attached again to the next WLAN access network 602a and MAG/WLAN 602 at the time point T2, that it loses connection with the WLAN access network 602a and the MAG/WLAN 602 at the time point T3, and that it is attached again to the next WLAN access network 603a and the MAG/WLAN 603. The interface If1 and the interface If2 in this embodiment may be of any access technology type. For instance, the 3G cellular interface If1 may be the WiMAX interface If3, and further, the WLAN interface If2 may be the WiMAX interface If3.

<Time Point T0>

At the time point T0, MN 600 refers to the prefix P1 by an RA message 605 via the 3G cellular interface If1 and the MAG/3GPP 618, and it refers to the prefix P2 by an RA message 606 via the WLAN interface If2 and the MAG/WLAN 601.

<Time Point T1>

Next, MN 600 moves along the locus 604 and the WLAN interface If2 loses connection with the MAG/WLAN 601 at the time point T1. In this case, MN 600 must transmit a vertical handoff trigger message 621 having only the HI flag (=2) to the MAG/3GPP 618 via the 3G cellular interface If1.

An important point to be understood in this case is as follows: Because MN 600 has only two interfaces In and If2, when MN 600 transmits the vertical handoff trigger message 621 to the MAG/3GPP 618, the prefix P2 is moved to the 3G cellular interface If1 while information of the identifier of the WLAN interface If2 is not notified by the message 621. The reason for this is that, when a PBU message (HI=2) (not shown) reaches the LMA/HA 619 from the MAG/3GPP 618, there is only one binding cache entry relating to the MAG/WLAN 601 and MN 600. For this reason, at the time point T1, MN 600 refers to the prefixes P1 and P2 by the RA message 607 received from the MAG/3GPP 618 after transmitting the trigger message 621. Although not shown in the figure, at the time point T0, MN 600 transmits an optimization request message to specify the prefix P2 as a floating prefix to the LMA/HA 619 either via the MAG/3GPP 618 or directly. As the time point T0, two connections (i.e. PDN (Packet Data Network) connections) are established. That is, the 3GPP interface If1 of MN 600 is connected to MAG/3GPP 618 and it may in the state that the prefixes P1 and P2 are assigned to each of these connections. In this case, at the time point T0, for the purpose of indicating that P2 is a connection (floating connection) to shift the connection where P2 is assigned among the connections established at the 3G cellular interface If1, MN 600 transmits an optimization request message including identification information (connection ID) associated with the connection, to which P2 is assigned, to the LMA/HA 619 and registers it. As the identification information, the prefix P2 may be used. At the time points T2 and T4, the vertical handoff trigger message is transmitted from the WLAN interface If2, and only the connection where the prefix P2 is assigned is shifted. Also, during the procedure to establish the connection to the 3GPP network, the fact that the prefix P2 is a floating prefix to be used at the WLAN interface If2 may be notified to MN 600. When this notification is received, MN 600 judges that there is no need to include the prefix P2 when the vertical handoff trigger message is transmitted via the WLAN interface If2 and the WiMAX interface If3.

<Time Point T2>

It is supposed here that MN 600 further moves along the locus 604 when it discovers the MAG/WLAN 602 of the new WLAN access network 602a at the time point T2, and that MN 600 wants to have the vertical handoff for the prefix P2. Here, it is assumed basically that MN 600 wants to transmit the prefix P2 always (uniquely) via the WLAN interface If2, and that it wants to send the prefix P1 via the 3G cellular interface If1. Therefore, at the time point T2, MN 600 triggers the vertical handoff at the MAG/WLAN 602 and notifies the prefix P2 to the MAG/WLAN 602 by the vertical handoff trigger message 622. The trigger message 622 in this case is a signal of new type. This is because the prefix P2 is selected from the prefixes P1 and P2 obtained via the 3G cellular interface If1, and it is shifted to the WLAN interface If2.

An important point to be understood in this case is that this operation is different from the operation described in the Non-Patent Document 2. In the fourth embodiment as shown in FIG. 8, MN 600 performs the vertical handoff to the prefix P2 to be referred via the WLAN interface If2 without shifting to the other prefix P1 relating to the 3G cellular interface If1. In this operation, MN 600 must use a new HI flag in the vertical handoff trigger message 622 and the LMA/HA 619 must notify the correct prefix P2 to the MAG/WLAN 602 by a PBA message (not shown) by referring to this new HI flag and the prefix P2.

An important point to be understood in this case is that, when the HI flag is not set to the new value as given above, the LMA/HA 619 performs processing on the PBU message (not shown) from the MAG/WLAN 602 by normal operation as described in the Non-Patent Document 2 and assigns both of the prefixes P1 and P2 to the MAG/WLAN 602. According to the draft of the Non-Patent Document 2, when MN 600, having two interfaces If1 and If2, executes the vertical handoff via the WLAN, all prefixes relating to the 3G cellular interface If1 are processed by handover to the WLAN interface If2. Basically, according to the draft based on the PMIPv6, all prefixes relating to the interfaces currently registered are shifted to the new interface during the vertical handoff. Under this assumption, therefore, in case MN 600 has two interfaces If1 and If2, a new HI option is needed to shift a certain prefix. For this reason, the wish of MN 600 requiring a specific prefix P2 must be instructed to the LMA/HA 619. The prefix P2 and the new HI option are inserted in a PBU message (not shown) by the MAG/WLAN 602, and it is transmitted to the LMA/HA 619. When the trigger message 622 is received at the time point T2 from the prefixes P1 and P2 assigned to the 3G cellular interface If1, the P2, which has been a prefix assigned to the WLAN interface previously, may be selected under the judgment by the LMA/HA 619, and this may be assigned to MN 600. In this case, even after the prefix 2 has been shifted to the 3G cellular interface If1, the LMA/HA 619 keeps in memory that P2 has been assigned to the WLAN interface If2 previously. In so doing, MN 600 has no need to use a new HI flag in the trigger message 622. In case it is explicitly described in the handover information (Inter-system mobility policy; Access Network Discovery Information) acquired from ANDSF (Access Network Discovery and Selection Function) server on the 3G network that the prefixes assigned to the WLAN interface If2 should be used as the prefix (floating prefix) to be continuously used after the vertical handover, MN 600 transmits the trigger message 622, not including the information to indicate the prefixes to be shifted (interface identifier or the prefix P2). As a result, it is possible to reduce the message size of the trigger message 622.

<Time Point T3>

It is assumed further that MN 600 roams in the PMIPv6 domain 620, that WLAN interface If2 loses connection with the WLAN access network 602a again at the time point T3, and that only the interface If1 is connected to MN 600. In this case, also, MN 600 carries out the vertical handoff of the prefix P2 by using the prefix P2 as desired and by using a new HI option.

This new flag is characterized in that the vertical handoff is performed between the 3G network and the WLAN to one prefix group where one prefix or a plurality of prefixes are selected. In this case, in the vertical handoff between the 3G network and the WLAN, a normal vertical handoff flag (HI=2) is used. This embodiment is advantageous in that the prefix to perform the vertical handoff is selected, and the vertical handoff is triggered only to the selected prefix. This embodiment provides a new method when MN 600 has the interfaces If1 and If2. This is because there is no need to notify the identifier of the interface If2 to perform the vertical handoff, and the packet size of the trigger message can be reduced.

<Processing of MN>

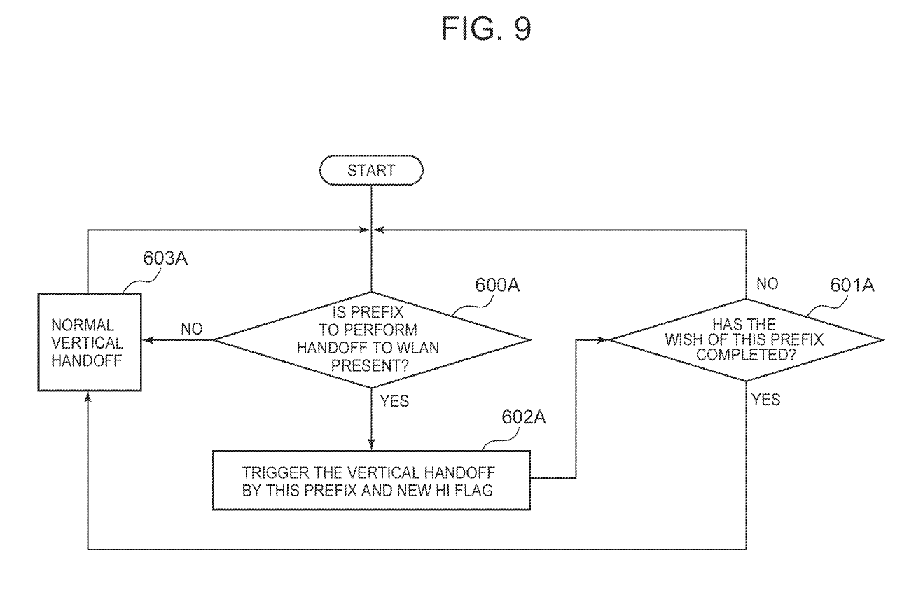

Referring to FIG. 9, description will be given on operation of MN 600. First, in Step 600A, it is checked whether or not there is a specific prefix to be referred via WLAN, for instance. If the answer is “No”, it is branched off to Step 603A. When it is necessary to perform the vertical handoff, normal vertical handoff processing is executed, and it goes back to Step 600A. In Step 603A, the vertical handoff trigger message with HI=2 for two interfaces If1 and If2 are transmitted. Basically, when there are two interfaces, there is no need to transmit the identifiers of the interfaces If1 and If2, and the PBU message with HI option would be sufficient for the purpose.

If the answer in Step 600A is “Yes”, it is advanced to Step 602A. The vertical handoff is triggered (a trigger message is transmitted) by the prefix to be referred and by a new HI option, and it is advanced to Step 601A. If the answer is “No” in Step 600A, it is branched off to Step 601A, and it is checked whether there is a wish to refer to the specific prefix via WLAN or not. For instance, in case a voice calling is started by using a specific prefix, the judgment in Step 601A will be “Yes”, and it is advanced to Step 603A. Then, the normal vertical handoff processing is carried out. In case the judgment in Step 601A is “No”, it goes back to Step 600A.

### The Fifth Embodiment

Next, referring to FIG. 10, description will be given on the fifth embodiment. The arrangement of the network shown in FIG. 10 is approximately the same as that of FIG. 8, except that it is assumed that MN 700 has two interfaces: the 3G cellular interface If1 and the WLAN interface If2, and also, that, when MN 700 roams along a locus 704, WLAN access networks 701a, 702a and 703a, to which WLAN interface If2 is attached, are continuous to each other. For this reason, it is assumed that the WLAN interface If2 of MN 700 is attached to the MAG/WLAN 701 at the time point T0, and it switches over the connection from the MAG/WLAN 701 to the MAG/WLAN 702 at the time point T1, and it is attached to the next MAG/WLAN 702 at the time point T2. Then, the connection is switched over from the MAG/WLAN 702 to the MAG/WLAN 703 at the time point T3, and it is attached to the next MAG/WLAN 703 at the time point T4. The interface If1 and the interface If2 in this embodiment may be of any access technology type. For instance, the 3G cellular interface If1 may be the WiMAX interface If2, or the WLAN interface If2 may be the WiMAX interface If3.

The difference between the fourth embodiment and the fifth embodiment will be described below. In the fourth embodiment, when no notification is given from the MAG/3GPP 618 to the MAG/WLAN 602 during the vertical handoff by the prefix P2, the LMA/HA 619 transmits the prefixes P1 and P2 to the WLAN interface If2. On the other hand, in the fifth embodiment, such continuous signaling is decreased. The reason for this is that, in the fifth embodiment, too, the vertical handoff rules of the two interfaces If1 and If2 are very static and MN 600 carries out the vertical handoff in a very static pattern. In the rules, the prefix P2 is shifted whenever MN 600 reaches the WLAN.

In the fifth embodiment, when the static rules are acknowledged, MN 700 transmits an optimization request message 705 of the vertical handoff to the MAG/3GPP 707 at the time point T0. The MAG/3GPP 707 transfers the contents of the message 705 to the LMA/HA 718 by a signaling message 706. As the transmission information, the message 705 contains vertical handoff information that the prefix P2 is shifted to the WLAN interface If2 when MN 700 reaches WLAN, and, if not, it is wished that it is shifted to the 3G cellular interface If1. That is, MN 700 transmits an optimization request message where the prefix P2 is set as a floating prefix. Major contents of the wishes of MN 700 to indicate to the LMA/HA 718 by the trigger message 705 are: the prefix P2 is shifted to the WLAN interface If2 when the vertical handoff trigger message reaches via WLAN interface If2, and the prefix P2 is shifted to the 3G cellular interface If1 when the vertical handoff trigger messages reaches via the 3G cellular interface If1. In this case, information of the 3G interface If1 and the WLAN interface If2 is included as the interfaces to continuously use the prefix P2 in the optimization request message 705 and the signaling message 706. When these rules are preset, there is no need to continuously transmit the vertical handoff trigger message having the prefix P2 during the time period when MN 700 is roaming in the PMIPv6 domain 719. At the time point T0, the 3GPP interface If1 of MN 700 is connected to the MAG/3GPP 707 and two connections (PDN) (Packet Data Network connections) are established, and the prefixes P1 and P2 are assigned to the connection respectively. In this case, at the time point T0, in order to indicate that the connection where P2 is assigned is a connection (a floating connection), to which the connection where P2 is assigned is shifted to the WLAN interface If2, among the connections established in the 3G cellular interface If1, MN 700 registers identification information (connection ID) associated with the connection where P2 is assigned to LMA/HA. As the identification information, the prefix P2 may be used as described in the present embodiment. At the time points T2 and T4, the vertical handoff trigger message is transmitted from the WLAN interface If2, and only the connection where the prefix P2 is assigned is shifted. During the procedure to establish the connection to the 3GPP network, it may be notified to MN 500 that the prefix P2 is a floating prefix to be used in the WLAN interface If2. When this notification is received, MN 500 judges that there is no need to include the prefix P2 when the vertical handoff trigger message is transmitted via the WLAN interface If2.

As the optimization request message 705, only the prefix to be used continuously may be specified, and the optimization request message 705 not including the access technology type (ATT) may be used. In this case, the LMA/HA 718 selects the prefix specified by the optimization request message 705 as a moving prefix regardless of the access technology type of the interface, via which the vertical handoff trigger message is transmitted. Also, a flag or the like may be included in the optimization request message 705 to indicate that the prefix to be notified is a prefix to be used continuously, and that it is a prefix not depending on the access technology type. Specifically, the prefix P1 used in the 3G interface If1 may be designated as a floating prefix. Thus, any arbitrary prefix may be selected and designated as a floating prefix, depending on the flow during the communication.

During the roaming in the PMIPv6 domain 719, MN 700 transmits vertical handoff trigger messages at the time points T1, T2 or T3. For instance, at the time point T1, the HI flag transmits two vertical handoff trigger messages 708 to the LMA/HA 718 via the 3G cellular interface If1. The case where the HI flag (=2) represents a case of normal operation. Therefore, when the LMA/HA 718 refers to HI flag=2, the prefixes P1 and P2 are assigned by the PBA message (not shown) destined to the MAG/3GPP 707.

When MN 700 moves further and performs the vertical handoff at the time point T2, there is no need to notify either the prefix P2 or the other prefix. It would suffice that the vertical handoff trigger message 712 with a new HI flag is transmitted to the MAG/WLAN 702 via the WLAN interface If2. When the LMA/HA 718 refers to this new HI flag in the PBU message 710 from the MAG/WLAN 702, and if the access technology type (WLAN) included in the same PBU message 710 falls under the category of the access technology type as registered in the optimization request message, the prefix P2 is assigned by the PBU message 711 destined to the MAG/WLAN 702. Therefore, MN 700 refers to the prefix P2 by the RA message 709 from the MAG/WLAN 702. By this new HI flag, MN 700 do not have to explicitly indicate the change of the vertical handoff rules. When the vertical handoff rules are changed, the HI flag is shifted to normal operation to transmit the vertical handoff trigger message where the HI flag is (=2). In this case, those skilled in the art would obviously understand that numerical value of the HI flag does not give limitation on the scope of the invention. The numerical value of the HI flag is defined by an organization such as IANA (Internet Assigned Number Association).

When the prefix P2 registered in the optimization request message is a prefix not limited to the access technology type and it is registered as a prefix continuously used, the LMA/HA 718 assigns the prefix P2 by the PBU message 711 destined to the MAG/WLAN 702 regardless of the access technology type upon receipt of the PBU message 710 including the new HI flag. In this case, it may be a normal type vertical handoff trigger message with the HI flag (=2). As a result, MN 700 has no need to include the access technology type in the optimization request message 705. Similarly, the MAG/WLAN 702 has no need to include the access technology type in the PBU message 710. Even when it is a vertical handoff trigger message 712 where the conventional HI flag value is set, the LMA/HA 718 can recognize that the selection of the prefix based on the preset rules is requested, and there is no need to use a new HI flag value.

The arrangement of MN 700 in the fifth embodiment of the invention is approximately the same as the arrangement of MN 500 in the first embodiment of the invention, and detailed description is not given here. The two interfaces of MN 700 as assumed in the fifth embodiment of the invention may be selected from three or more interfaces, which MN 700 possesses. Further, the method to use the optimization request message 705 to register the prefix P2 as the prefix not limited by the access technology type and to be continuously used can also be applied in the first embodiment of the present invention. The fifth embodiment of the present invention provides such effects that, after registering the prefix to be continuously used in the optimization request message 705, MN 700 has no need to explicitly include the prefix to be shifted in the vertical handoff trigger message, which is transmitted when the vertical handoff is executed.

### The Sixth Embodiment

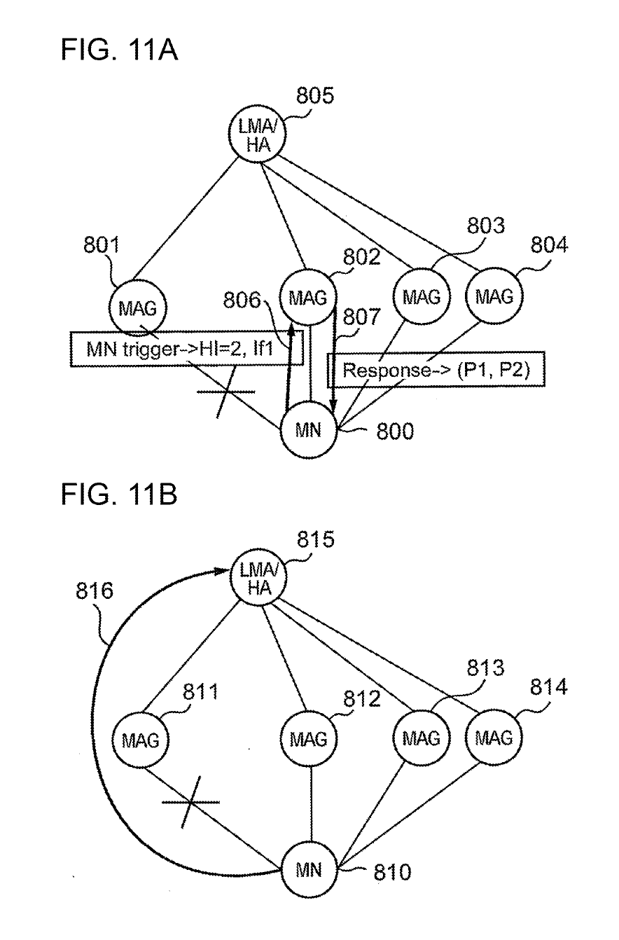

Next, referring to FIG. 11A and FIG. 11B, description will be given on the sixth embodiment. FIG. 11A shows that MN 800 has four interfaces of If1, If2, If3 and If4, and that it is attached to the PMIPv6 domain for routing to the LMA/HA 805. Here, it is supposed that MN 800 refers to the prefix P1 via the interface If1 and MAG 801, refers to the prefix P2 via the interface If2 and MAG 802, refers to the prefix P3 via the interface If3 and MAG 803, and refers to the prefix P4 via the interface If4 and MAG 804.

When MN 800 decides to shut down the interface If1, MN 800 transmits a vertical handoff trigger message 806 (MN trigger->HI=2; If1 in the figure) in the first step to MAG 802 via the interface If2 and notifies the prefix P1. When this trigger message 806 is received by a PBU message (not shown), the LMA/HA 805 transmits a response by a PBA message (not shown) to MAG 802, and MAG 802 transmits a response message 807 (Response->P1, P2 in the figure) to MN 800. Basically, MN 800 refers to both of the prefixes P1 and P2 via the response message 807. When MN 800 in roaming must execute the vertical handoff of the interface If2 for some reason, MN 800 must continuously transmit information of the prefix P1 or identifier of the interface If2. Therefore, it is necessary to optimize the transmission information.

Then, the information of the prefix P1 is eliminated so that the information relating to the prefix P1 is not maintained in any MAG within the system. FIG. 11B shows an example. Basically, MN 810 transmits a message 816 to bind the prefix P1 with the other prefixes P2, P3 and P4, and this is transmitted to the LMA/HA 815. As a result, a routing state for the prefix P1 is not maintained in any of MAG within the system, and there is no need to perform the vertical handoff for the prefix P1. However, it is necessary to perform a certain tunneling procedure so that MN 810 can transmit and receive the flow of the prefix P1. The flow of the prefix P1 is tunnelized to the address relating to the prefix P2 and adequate routing is carried out. Major advantage by this method is that there is no need to maintain the state relating to the prefix P1 in any of MAG within the system. However, tunneling is needed for receiving the packet destined to the address relating to the prefix P1.

In the above, description has been given on embodiments of the present invention, while those skilled in the art would obviously understand that various changes and modifications can be conceived without departing from the spirit and the scope of the invention. For instance, as a system described in the network arrangement used for the explanation of the embodiments, the application of SAE (System Architecture Evolution) under 3GPP-LTE (The Third Generation Partnership Project Long Term Evolution) can be conceived. When matching is made on the relation between the system shown in FIG. 1 and SAE, the LMA/HA is PDN-GW (Packet Data Network Gateway), which is present in the 3GPP network, and the MAG/3GPP is S-GW (Serving Gateway). Also, the MAG/WiMAX is ePDG (Evolved Packet Data Gateway) existing in a Non-3GPP network. Further, the MAG/WLAN is AGW (Access Gateway) existing in the Non-3GPP network, and MN is a user equipment (UE). In this case, in the 3GPP network, connection is made to the LMA/HA by using GTP (Generic Tunneling Protocol) or PMIP (Proxy Mobile IP). In the Non-3GPP network, connection is made to the LMA/HA by using PMIP. Even when GTP is used in the 3GPP network, the method explained in the embodiments of the invention can also be applied. Each functional block used in the description of the embodiments of the present invention as given above can be realized as LSI (Large Scale Integration), typically represented by the integrated circuit. These may be produced as one chip individually or may be designed as one chip to include a part or all. Here, it is referred as LSI, while it may be called IC, system LSI, super LSI, or ultra LSI, depending on the degree of integration. Also, the technique of integrated circuit is not limited only to LSI, and it may be realized as FPGA (Field Programmable Gate Array), which can be programmed after the manufacture of LSI, or a reconfigurable processor, in which connection or setting of circuit cell inside LSI can be reconfigured, may be used. Further, with the progress of semiconductor technique or other techniques derived from it, when the technique of circuit integration to replace LSI may emerge, the functional blocks may be integrated by using such technique. For example, the adaptation of biotechnology is one of such possibilities.

### INDUSTRIAL APPLICABILITY

The present invention provides such effects that packet size of signaling to require the vertical handoff can be reduced in case a mobile node has the static vertical handoff rules, and it can be applied in the PMIPv6 domain where the protocol of the PMIPv6 is adopted in the 3GPP Service Architecture Evolution (SAR) local domain.

1. A vertical handoff method, where a mobile node having a first to a third interfaces connectable to a first to a third networks respectively, being provided with a proxy mobile IP under management by a common management node, said mobile node roams in said first to said third networks and said second or said third interface is selectively and newly connected to said second or said third network, wherein said method comprises:
a prefix setting step for setting said prefix on a home agent of said mobile node in order that said second or said third interfaces can be continuously used after said vertical handoff, and a prefix different from that of said first interface, being used before the vertical handoff to said second to said third network, can be used by said second or said third interface;
a step where said mobile node transmits a trigger message of the vertical handoff, including a vertical handoff flag and not including identifiers of said second or said third interface newly connected, to said home agent from said second and said third interfaces newly connected; and
a step where said home agent detects said vertical handoff flag in said trigger message, and the prefix set in said prefix setting step is shifted to said second or said third interface newly connected from said second or said third interface previously connected.

2. The vertical handoff method according to claim 1, wherein said mobile node decides the prefix to be continuously used in said prefix setting step and sets the prefix on said home agent.

3. The vertical handoff method according to claim 1, wherein said home agent learns a moving route of said mobile node and decides said prefix to be continuously used in said prefix setting step.

4. A vertical handoff system, where a mobile node having a first interface to a third interface, being connectable respectively to a first network to a third network, to which a proxy mobile IP managed by a common management node is provided, said mobile node roams within said first network to said third network, and said second interface or said third interface is selectively and newly connected to said second network or said third network, wherein said system comprises:
prefix setting means for setting a prefix to a home agent of said mobile node in order that a prefix different from said first interface and being in use before vertical handoff to said second network or said third network by said second interface or said third interface is continuously used via said second interface or said third interface after said vertical handoff;
means for transmitting where said mobile node transmits a trigger message of vertical handoff, including a vertical handoff flag and not including an identifier of said second interface or said third interface newly connected, from said second interface or said third interface newly connected to said home agent; and
means, by which said home agent detects said vertical handoff flag in said trigger message and transfers the prefix set by said prefix setting means from said second interface or said third interface previously connected to said second interface or third interface newly connected.

5. The vertical handoff system according to claim 4, wherein said prefix setting means is characterized in that said mobile node decides said continuously used prefix and sets said prefix on said home agent.

6. The vertical handoff system according to claim 4, wherein said prefix setting means is characterized in that said home agent learns a moving route of said mobile node and decides said continuously used prefix.

7. A mobile node, having a first interface to a third interface connectable to a first network to a third network respectively where a proxy mobile IP managed by a common management node is provided, said mobile node is roaming in said first network to said third network and said second interface or said third interface performs vertical handoff to said second network or said third network newly connected selectively, wherein said mobile node comprises:
means for transmitting a trigger message of vertical handoff, including a vertical handoff flag and not including an identifier of said second interface or said third interface newly connected, said trigger message being transmitted to a home agent of a mobile node from said newly connected second interface or said third interface.

8. The mobile node according to claim 7, wherein said second interface or said third interface determines to continuously use a prefix different from said first interface, being used before vertical handoff to said second interface or said third interface has been using before the vertical handoff to said second network or said third network, and said prefix is set on said home agent.

9. A home agent of a mobile node in a vertical handoff system, where a mobile node having a first interface to a third interface connectable to a first network to a third network respectively, where a proxy mobile IP managed by a common management node is provided, said mobile node roams in said first network to said third network, and said second interface or said third interface is selectively and newly connected to said second network or said third network, wherein said home agent comprises:
prefix memorizing means for memorizing a prefix different from said first interface and being used before the vertical handoff by a second interface or a third interface of said mobile node to said second network or said third network;
means for receiving a trigger message, being transmitted from said second interface or said third interface newly connected of said mobile node and including a vertical handoff flag and not including an identifier of said newly connected second interface or said third interface; and
means for detecting said vertical handoff flag in said trigger message and for transferring a prefix memorized in said prefix memorizing means to said second interface or said third interface newly connected from the second interface or the third interface previously connected.

10. The home agent according to claim 9, wherein said prefix memorizing means memorizes a prefix as decided and notified by said mobile node as a prefix to be continuously used before and after the vertical handoff to said second network or said third network by said second interface or said third interface of said mobile node.

11. The home agent according to claim 9, wherein said prefix memorizing means memorizes a prefix decided by a home agent through learning of a moving route of said mobile node as a prefix to be continuously used by said mobile node.

12. (canceled)

13. (canceled)

14. (canceled)

15. (canceled)
